(19) United States
(12) Patent Application Publication
(10) Pub. No.: US 2006/0248105 A1
(43) Pub. Date: Nov. 2, 2006

(54) Interactive system for building and sharing databank

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/556,160

(22) PCT Filed: Oct. 23, 2003
(86) PCT No.: PCT/IN03/00342

§ 371 Date: Nov. 8, 2005

(30) Foreign Application Priority Data
May 14, 2003 (IN) 489/MUM/2003

(51) Int. Cl. G06F 7/00

(52) U.S. Cl. 707/102

(57) ABSTRACT

Interactive system for building and sharing one's own databank of the text and other related information of musical compositions in one or more languages, it being accepted that one may want to build such data based on one's personal interest that uses a computer system.

### FIELD OF INVENTION

The present invention relates to an interactive system for building (including, saving, appending, retrieving, modifying) and sharing one's own databank of the text and other related information of musical compositions including but not limited to songs, hymns, ghazals, in one or more languages in a well-classified manner:, it being accepted that musical compositions including songs, hymns, ghazals are part of people's daily social lives.

### BACKGROUND OF THE INVENTION

It is a well-accepted fact that musical compositions have been part of people's daily social lives from time immemorial and it is a common habit for most people to hum and sing the same to themselves and to others. It is a well-accepted fact that musical compositions are popular with one and all, and therefore there are several types of businesses involved in the production of the same.

Since musical compositions are a popular and an integral part of society, there are several Music clubs and Television/Radio programs based on them. It is a well-accepted fact that musical compositions are an important ingredient of films and theatre. Also, there are several karaoke bars where songs are sung with the text of the same being displayed. It is well known that traditionally, it is only the actual musical compositions that are stored on Recording media like cassettes and CDs, while their text as such is not readily or always available along with the same.

It is well known that the text of musical compositions, when available in the printed form as Songbooks, etc. are not classified comprehensively. Furthermore, such data is not published regularly and people have to wait for new editions to be published to be able to access updated data. Where such data is available over the Internet, the classification of data is not comprehensive or necessarily user-friendly and may not always allow users to conveniently locate or find data for their use.

It is well known that during the grooming years of a child, nursery rhymes are used as a tool to enhance a child's learning abilities, create strong phonic building blocks and sharpen listening skills. It is a well-accepted fact that nursery rhymes have been identified as an excellent way to develop this awareness. It would be useful for parents and teachers to be able to store and display such nursery rhymes by well-defined classifications, to enhance and enrich the learning experience. It is a well-accepted fact that, with the advent of cellular phones, the tunes of musical compositions have become very popular in the form of ring tones. It would be useful for users of cellular phones to store additional information relating to the ring tone, like the Category of the Song, Title of the Song, Singer(s)/Band, etc., as well as to compose and edit ring tones.

It is a well-accepted fact that jingles featured in advertisements of products and services are quite popular and used as effective marketing tools. It is also a well-known fact that people identify particular products and services by their corresponding jingles. It would be useful for enthusiasts to store additional information relating to the jingles, like the product or service advertised, Title of jingle, Singer(s)/Artiste(s) etc. It is a well-known fact that musical compositions are often recorded by singers, songwriters and lyricists in their own voice. It would be useful for such singers, songwriters and lyricists if there were to exist a system which would allows them to Add, Retrieve, Modify, Delete, Print, Export, Import, Schedule the text and other related information of their own musical compositions, record the musical composition with or without accompaniment of musical instruments, and to be able to review the same for enhanced appreciation.

It is a well-accepted fact that many people learn and impart vocal skills on a professional or amateur basis. It would be helpful for such people to learn and impart the same by well-defined classifications, if there were to exist a system which would allow them to Add, Retrieve, Modify the text and other related information of musical compositions, by well-defined classifications, thereby helping them to remember the text and other related information of the same.

It is a well known fact that in some countries like India, there exists a popular form of family entertainment by the name “Antakshari”, where the participants are challenged, amongst other ways, by being asked to sing songs beginning with a particular letter or syllable or word, and it would be very helpful for people taking part or wishing to take part in such events/activities were to exist a system which would allow a user to Add, Retrieve, Modify, Delete, Print, Export, Import, Schedule the data comprising of the text and other related information of musical compositions, by well-defined classifications, thereby helping them to remember the text and other related information of the same.

It is a well accepted fact that people generally cannot remember a large amount of data, whether by classifications or not, without external help, and it would be very helpful if there were to exist a system that would help people to Add, Retrieve, Modify, Delete, Print, Export, Import, Schedule the data comprising of the text and other related information of musical compositions, thereby helping people to better remember the same for use in daily life.

U.S. Pat. No. 4,712,174 relates to a Method and apparatus for generating text which uses a computer based system for generating text from a predetermined data base, in either prose or poetic form, in response to a plurality of input data provided by an operator in an interactive mode of operation with the computer. The preferred embodiment disclosed produces limerick style poetry in response to name, gender, geographic place of residence, primary and secondary traits and the number of syllables in certain input data items, and includes poetic material related to each of these data input items.

U.S. Patent Application Publication No. 2003036040 relates to Basic poetry generation comprising a method of analyzing an author's work, including reading a text file, generating an analysis model from the text file and storing the analysis model. The text file may be a poem, the poem containing ASCII text. The analysis model is a linked data structure. The linked data structure includes n-gram data structures, the n-gram structures including combinations of 1-gram data structures, bigram data structures, trigram data structures and quadrigram data structures

Japanese Patent JP11219195 relates to a system to support the sensitive activity of human beings by a computer so as to considerably enlarge the use range of the computer by recognizing a phrase uttered by a user, determining a phrase to be outputted on the basis of the recognized result, and outputting this phrase as voice. A system control instructs the output of a first phrase of a transition diagram to a sound output. According to this instruction, the sound output outputs the voice of the phrase. At the same time, the system control part 1 instructs the start of voice recognition to a voice recognizing part. A user listens to the phrase outputted from a speaker of a system, selects a favorite phrase from a plurality of phrases connectible to the outputted phrase and reads it toward a microphone. The voice recognizing part recognizes it, and the system control part determines a phrase to be connected next using the transition diagram from the recognized result and instructs its output to the sound output part.

U.S. Pat. No. 6,525,251 relates to a method of displaying the title and words of songs on a portable digital music player includes the steps of using an editing software to edit words of songs into pages, storing the pages of words of the songs in the hard disk drive of a computer for enabling the computer to automatically display the edited words on the screen when playing the selected song, recording the time for displaying each page of the words of the song played through the computer, driving the computer to store the file after the end of the play of the song, transferring the storage data from the computer to the memory of the portable digital music player, and driving the portable digital music player to display page by page the words of the song being played by the portable digital music player.

The prior art described in the foregoing descriptions have an inherent limitation, in that, they do not allow the users to build their own databank of the text and other related information of musical compositions by well-defined classifications, and further that none of the above prior art assist in the improvement of one's knowledge of the same by allowing users to take Music Session(s), and that none of the above prior art allow the users to share such data with others.

Therefore, by dint of determined research and intuitive knowledge, our inventor has developed an interactive System that enables users to build (including saving, appending, retrieving, modifying) their own databank of the text and other related information of musical compositions including but not limited to songs, hymns and ghazals in one or more languages, by well-defined classifications, Translate the same into one or more languages, and which further enables users to improve their knowledge of the same by means of taking Music Sessions and Scheduled displays; which further enables users to Export data to other users of this System, and which further enables users to Import data built by other users of this System.

### BRIEF SUMMARY OF THE INVENTION

An object of the present invention is to provide an interactive System for building and sharing one's own databank of the text and other related information of musical compositions, it being accepted that one may want to build (including saving, appending, retrieving, modifying) such data in one or more languages, based on one's personal interest and further store it by various classifications like Type, Age group, Genre, Category etc., such classification of data not restricted to any already provided data.

Yet another object of the present invention is to allow users to FIND such data rapidly and efficiently by none or one or more FIND conditions.

Yet another object of the present invention is to allow users to Customize the data by allowing the Modification of the same, allowing the Addition of Bookmark Remarks, Associations, Files, including Media files, URLs and more Remarks to the same.

Yet another object of the present invention is to allow users to Bookmark selected Records as “Set for Practice” or “Mastered”, “Public” or “Private” as well as “Favourite” and assign the same to specific users or user groups.

Yet another object of the present invention is to allow users to Navigate efficiently between the Records.

Yet another object of the present invention is to allow users to Modify data individually and Globally, and further selectively.

Yet another object of the present invention is to allow users to share data created by the users using the Export/Import/Print Modules, such Exporting/Importing/Printing of data capable of being done selectively. Yet another object of the present invention is to provide users with the utility of Deleting the data, the scope of deleting data being singular or Global, sending the deleted data to the Recycle Bin Module of the System, and further deleting the same, singularly or plurally, and/or restoring the same, singularly or plurally.

Yet another object of the present invention is to allow users to invoke a Music Session(s) using the stored data and finding the same by none or one or more classifications that the user may have used to create and/or modify such data, and further to use the data selected for the Session(s) as screen savers.

Yet another object of the present invention is to allow the user to Schedule the data comprising of the text and other related information of musical compositions by none or one or more classifications that the user may have used to create and/or modify the same, to be brought up on the user's computer, including hand held devices, at preset time intervals, with or without Voice.

Yet another object of the present invention is to provide various Reports selectively and having the further utility of customizing the same.

Yet another object of the present invention is to provide the necessary Tools to the user for better customization and maintenance of the System in various ways.

Yet another object of the present invention is to allow one or more module(s)/utility(s) to Operate within a browser and/or other viewing and/or processing programs, and which can Operate on one or more computer systems, including hand held devices.

Yet another object of the present invention is to provide a utility for creating, editing, deleting, printing, navigating, finding Masters like Type, Age Group, Genre, Category, First Letter/Syllable/Word, Singer(s)/Band, Film/Album, Music Composer(s)/Director(s), Lyricist(s), Year of Release of the Film/Album, with sufficient security so as not to allow the deletion of any Master of a Record that may be in use.

Yet another object of the present invention is to provide users with a Translation utility, allowing the user to consider any Record as a parent language Record and Translate the same into one or more languages of the user's choice, the translation activity happening from a Translation Module which is invoked in the Music Bank Module, and further that all of the features and/or utility(s)/functionality(s) of the System remaining common to the translated Record as would be applicable to the parent language Record.

Yet another object of the present invention is to allow the user to Print any Record of the user's choice as well as to obtain a plurality of Reports.

Yet another object of the present invention is to provide sufficient security of not allowing the deletion of a Record or a Master that may be in use.

Yet another object of the present invention is to allow the user to input and/or Modify data in the Music Bank Database/Translation Database by Voice input, with or without a conjunction of input made by keyboard support, and/or to use any other utility(s)/functionality(s) of the System, as may be supported by the System for such use, by Voice Command, and further to allow the user to receive Voice Output of the data so entered/modified by the user in the above Music Bank Database/Translation Database.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:

FIG. 1 is the diagram of the System block of the present invention.

FIG. 2 is the diagram of the Multiple User System of the present invention FIG. 3 is the diagram of the Outline of the System Process of the present invention

FIG. 4 is the diagram of the System Function of the Music Bank Module of the present invention

FIG. 5 is the diagram of the System Operation of the Music Bank Module of the present invention

FIG. 6 is the diagram of the System State Transition of the Music Bank Module of the present invention

FIG. 7 is the diagram of the System Function of the Global Association Module of the present invention

FIG. 8 is the diagram of the System Operation of the Global Association Module of the present invention

FIG. 9 is the diagram of the System State Transition of the Global Association Module of the present invention

FIG. 10 is the diagram of the System Function of the Global Attachment Module of the present invention

FIG. 11 is the diagram of the System Operation of the Global Attachment Module of the present invention

FIG. 12 is the diagram of the System State Transition of the Global Attachment Module of the present invention

FIG. 13 is the diagram of the System Function of the Music Session Module of the present invention

FIG. 14 is the diagram of the System Operation of the Music Session Module of the present invention

FIG. 15 is the diagram of the System State Transition of the Music Session Module of the present invention

FIG. 16 is the diagram of the System Function of Reports Module of the present invention

FIG. 17 is the diagram of the System Operation of Reports Module of the present invention

FIG. 18 is the diagram of the System State Transition of Reports Module of the present invention

FIG. 19 is the diagram of the System Function of the Global Modification Module of the present invention

FIG. 20 is the diagram of the System Operation of the Global Modification Module of the present invention

FIG. 21 is the diagram of the System State Transition of the Global Modification Module of the present invention

FIG. 22 is the diagram of the System Function of the Global Delete Module of the present invention

FIG. 23 is the diagram of the System Operation of the Global Delete Module of the present invention

FIG. 24 is the diagram of the System State Transition of the Global Delete Module of the present invention

FIG. 25 is the diagram of the System Function of the Global Bookmark/Unbookmark Module of the present invention

FIG. 26 is the diagram of the System Operation of the Global Bookmark/Unbookmark Module of the present invention

FIG. 27 is the diagram of the System State Transition of the Global Bookmark/Unbookmark Module of the present invention

FIG. 28 is the diagram of the System Function of the Export Module of the present invention

FIG. 29 is the diagram of the System Operation of the Export Module of the present invention

FIG. 30 is the diagram of the System State Transition of the Export Module of the present invention

FIG. 31 is the diagram of the System Function of the Import Module of the present invention

FIG. 32 is the diagram of the System Operation of the Import Module of the present invention

FIG. 33 is the diagram of the System State Transition of the Import Module of the present invention

FIG. 34 is the diagram of the System Function of the Music Scheduler Module of the present invention

FIG. 35 is the diagram of the System Operation of the Music Scheduler Module of the present invention

FIG. 36 is the diagram of the System State Transition of the Music Scheduler Module of the present invention

FIG. 37 is the diagram of the System Function of the Recycle Bin Module of the present invention

FIG. 38 is the diagram of the System Operation of the Recycle Bin Module of the present invention

FIG. 39 is the diagram of the System State Transition of the Recycle Bin Module of the present invention

FIG. 40 is the diagram of the System Function of the Tools/Help Menu Options Module of the present invention

FIG. 41 is the diagram of the System Operation of the Tools/Help Menu Options Module of the present invention

FIG. 42 is the diagram of the System State Transition of the Tools/Help Menu Options Module of the present invention

FIG. 43 is the diagram of the System Function of the Translation Module of the present invention

FIG. 44 is the diagram of the System Operation of the Translation Module of the present invention

FIG. 45 is the diagram of the System State Transition of the Translation Module of the present invention

FIG. 46 is the diagram of the System Function of the Global Translation Module of the present invention

FIG. 47 is the diagram of the System Operation of the Global Translation Module of the present invention

FIG. 48 is the diagram of the System State Transition of the Global Translation Module of the present invention

FIG. 49 is the diagram of the System Function of the Master Module of the present invention

FIG. 50 is the diagram of the System Operation of the Master Module of the present invention

FIG. 51 is the diagram of the System State Transition of the Master Module of the present invention

### DETAILED DESCRIPTION OF THE PRESENT INVENTION

A detailed description of the preferred embodiments and best modes for practicing the present invention are described herein.

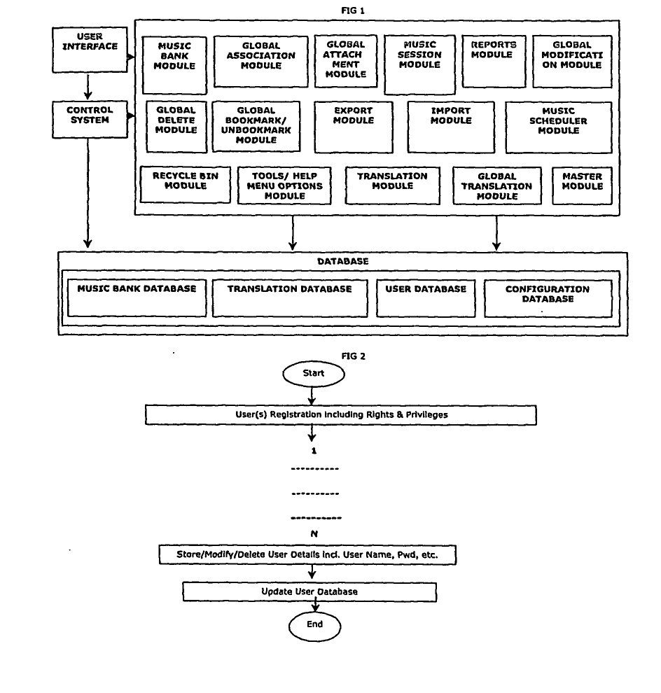

Interactive System for building and sharing one's own databank of the text and other related information of MUSICAL COMPOSITIONS including, SONGS, HYMNS, GHAZALS, wherein FIG. 1 is the diagram of the different functional blocks and their interaction of the present invention. The User Interface renders the user's actions, and with the help of the Control System transmits the appropriate requests to the Database. The Control System acts as the bridge between the User Interface and the Database.

The Database consists of Music Bank Database, Configuration Database, User Database, and the Translation Database. The Music Bank Database is the reservoir of an extensible collection of well-classified data. The User Database is the reservoir of the user information and also contains the history of past user interaction with the system. The Configuration Database is the reservoir of the options used for the Customization of the System. The Translation Database is the reservoir of the translated data.

If the user requests for the Music Bank Module through the User Interface, then the Control System asks the Database Management System to find the corresponding data from the Music Bank Database/Translation Database, resulting in the display of the relevant data, if available. The user then interacts further with the Music Bank Module through the User Interface.

If the user requests for the Global Association Module through the User Interface, then the Control System finds the corresponding data from the Music Bank Database/Translation Database resulting in the display of the relevant data, if available. The user then interacts further with the Global Association Module through the User Interface.

If the user requests for the Global Attachment Module through the User Interface, then the Control System finds the corresponding data from the Music Bank Database/Translation Database resulting in the display of the relevant data, if available. The user then interacts further with the Global Attachment Module through the User Interface.

If the user requests for the Music Session Module through the User Interface, then the Control System asks the Database Management System to find the corresponding data from the Music Bank Database/Translation Database, resulting in the display of the relevant data, if available. The user then interacts further with the Music Session Module through the User Interface.

If the user requests for the Reports Module through the User Interface, then the Control System asks the Database Management System to find the corresponding data from the Music Bank Database/Translation Database, resulting in the display of the relevant data, if available. The user then interacts further with the Reports Module through the User Interface. Where any Report relates to user information, then the Control System asks the Database Management System to find the corresponding data from the User Database.

If the user requests for the Global Modification Module through the User Interface, then the Control System finds the corresponding data from the Music Bank Database/Translation Database, resulting in the display of the relevant data, if available. The user then interacts further with the Global Modification Module through the User Interface.

If the user requests for the Global Delete Module through the User Interface, then the Control System finds the corresponding data from the Music Bank Database/Translation Database, resulting in the display of the relevant data, if available. The user then interacts further with the Global Delete Module through the User Interface.

If the user requests for the Global Bookmark/Unbookmark Module through the User Interface, then the Control System finds the corresponding data from the Music Bank Database/Translation Database resulting in the display of the relevant data, if available. The user then interacts further with the Global Bookmark/Unbookmark Module through the User Interface.

If the user requests for the Export Module through the User Interface, then the Control System finds the corresponding data from the Music Bank Database/Translation Database, resulting in the display of the relevant data, if available. The user then interacts further with the Export Module through the User Interface.

If the user requests for the Import Module through the User Interface, then the Control System retrieves the corresponding data from a valid database file resulting in the display of the relevant data, if available. The user then interacts further with the Import Module through the User Interface.

If the user requests for the Music Scheduler Module through the User Interface, then the Control System asks the Database Management System to find the corresponding data from the Music Bank Database/Translation Database, resulting in the display of the relevant data, if available. The user then interacts further with the Music Scheduler Module through the User Interface.

If the user requests for the Recycle Bin Module through the User Interface, then the Control System retrieves the corresponding data from the Music Bank Database/Translation Database resulting in the display of the relevant data, if available. The user then interacts further with the Recycle Bin Module through the User Interface.

If the user requests for the Tools/Help Menu Options Module through the User Interface, then the Control System retrieves the corresponding Options available from the Configuration Database. The user then interacts further with the Tools/Help Menu Options Module through the User Interface.

If the user requests for the Translation Module through the User Interface, then the Control System finds the corresponding data from the Music Bank Database/Translation Database, resulting in the display of the relevant data, if available. The user then interacts further with the Translation Module through the User Interface.

If the user requests for the Global Translation Module through the User Interface, then the Control System finds the corresponding data from the Music Bank Database/Translation Database resulting in the display of the relevant data, if available. The user then interacts further with the Global Translation Module through the User Interface.

If the user requests for the Master Module through the User Interface, then the Control System finds the corresponding data from the Music Bank Database/Translation Database resulting in the display of the relevant data, if available. The user then interacts further with the Master Module through the User Interface.

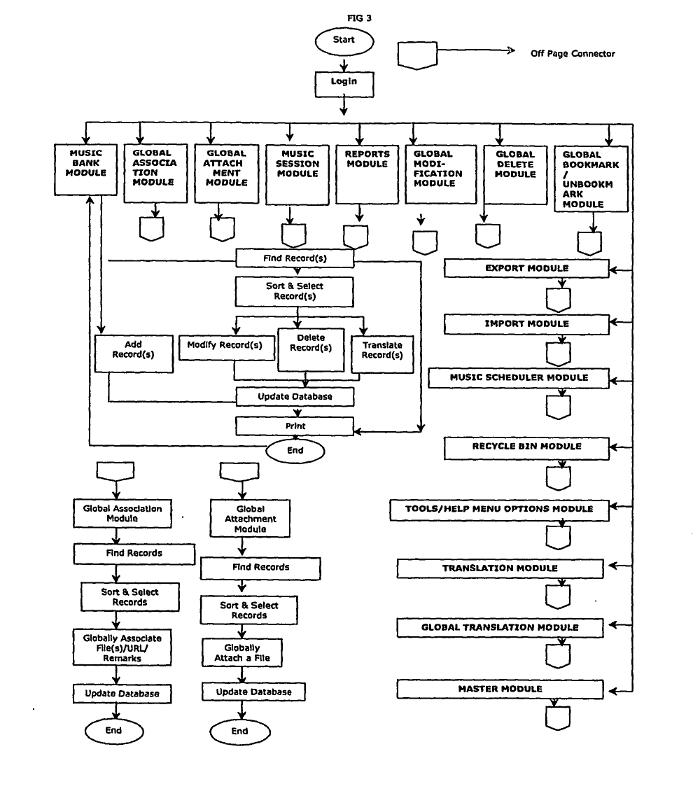

FIG. 2 is the diagram of the Multiple User System of the present invention. It explains that multiple users can use the System at the same time, and also explains that the System can be controlled by rights and privileges.

FIG. 3 is the diagram of the outline of the System process of the present invention. It exhibits the modules of the System and their main functions.

FIGS. 4 to 12 explain the System Function, System Operation, System State Transition of the Music Bank Module, the System Function, System Operation, System State Transition of the Global Association Module, the System Function, System Operation, System State Transition of the Global Attachment Module, respectively of the present invention. The Module(s) accepts data (such data capable of being accepted from more than one user at the same time), with or without voice, from the user, by well-defined classifications like (1) Date, (2) Type, (3) Age group ( ), (4) Genre (the kind of genre this musical composition belongs to—EXAMPLE—Rock Music), (5) Category (particular category for which this musical composition is appropriate—EXAMPLE—Romantic Music), (6) Title (7) First Letter/Syllable/Word (the first letter of the actual lyrics of the musical composition), (8) Singer(s)/Band(s) (the name of the singer(s)/band(s)—EXAMPLE—Frank Sinatra), (9) Music Director(s)/Composer(s) (the name of the Music director(s)/composer(s)—EXAMPLE—Sir Andrew Lloyd Webber), (10) Lyricist(s) (the name of the Lyricist(s)—EXAMPLE—Babyface), (11) Film/Album, (12) Year of release of the Film or Album, (13) Actor(s) who the song was picturised on, (14) Scene Description, (15) Awards (the awards/honours won by the musical composition), (16) Main Instrument(s). This Module further allows the user to Attach and/or Associate any kind of additional information like File(s), URLs and Remarks, File(s) and URLs being able to be opened by the System, the Remarks being simply displayed—EXAMPLE—The user may want to attach an IMAGE or an ANIMATION or a SOUND file (including a recording of the musical composition in the user's voice) to the Record, or the user may also want to Associate more information to the Record by means of associating some information that may be on a File or a Web Site, and hence the user would associate a File or URL to the Record. Such File(s) would be opened by the System. In case of a URL, the same would be opened by the System provided the user is connected to the Internet. The user may also simply wish to Add a REMARK to the Record. Such REMARKS are displayed to the User with the Record.

The Module also provides a utility to Add specialized Remarks as “Bookmark Remarks”, as well as a utility to Bookmark any selected Record(s) as “Set for Practice” or “Mastered”, “Public” or “Private”, as well as “Favourite”, and further assign the same to specific users or user groups. A Global utility allows the user to Bookmark a set of Records as “Set for Practice” or “Mastered”, “Public” or “Private”, as well as “Favourite” Globally, across multiple Records, by finding the same from the Music Bank Database/Translation Database, by none or one or more FIND conditions, instead of Bookmarking the same one by one.

All of the above classifications and additional details and information are user defined, and can be modified to suit the user, thereby providing full flexibility to the user.

The Module also comprises of the utility, while adding a new data Record, of copying an existing entry with respect to at least the above classifications under which the entry may have been stored, such “Copy Current Entry” utility being of immense use to the user to simplify the creation of Records having at least common classifications.

The Module also comprises of the utility of Printing a Record stored in the Music Bank Database/Translation Database. The Records can be Printed by finding the same from the Music Bank Database/Translation Database based on none or one or more FIND conditions, the Results being displayed to the user in a grid format with a further utility to Sort the Results, Ascending or Descending, by the relevant classifications, and further allowing the user to select the Records to be Printed from the result grid. The Printing utility offers further selections to be made by the user with respect to various Print conditions such as Printing a single Record, or Printing the results without further selections, or Printing the results selectively, or Printing the entire set of Records available in the database with further selections, if needed. The Printing utility further comprises of the Print reports to be Exported to various destinations in various file formats. The Printing utility provides the user with the ability to customize the Header and Footer details.

The Module also comprises of the utility of Navigating between Records in the Music Bank Database/Translation Database.

The Module comprises of the utility of finding Records in the Music Bank Database/Translation Database, by none or one or more of the above classifications and/or keywords, File Attachments or Bookmark Remarks including “Set for Practice” or “Mastered”, “Public” or “Private”, as well as “Favourite”, the Find Results being displayed to the user in a grid format with a further utility to Sort the Find Results, Ascending or Descending, by the relevant classifications that may have been used by the user to enter and/or Modify the Records in the Music Bank Module. Double clicking on any Record will take the user to the concerned Record.

A further utility allows the user to send the Record as SMS/MMS and/or via Email and/or Network Messaging.

The user is allowed to input and/or Modify data in any of the Music Bank Database/Translation Database by Voice input, with or without a conjunction of input made by keyboard support, and/or use any other utility(s)/functionality(s) of the System, as may be supported by the System for such use, by Voice Command, and further that the text to speech technology used enables the System to speak out the data so entered/modified by the user in the above Music Bank Database/Translation Database.

Any data from the Music Bank Database/Translation Database can be deleted by the user by finding the same based on none or one or more FIND conditions.

Any Record can be translated by the user into one or more languages by finding the same from the Music Bank Database/Translation Database based on none or one or more FIND conditions.

Any data entered or imported into the Music Bank Module is further used as part of the functions of the other Modules of the System.

FIG. 4 is the diagram of the System Function of the Music Bank Module of the present invention. The architecture of this Module comprises the following functions, which allow a user to create and store the text and other related information of musical compositions by well-defined classifications with the help of the User Interface.

The Music Bank Module through the User Interface causes the Control System to find and Retrieve the relevant data from the Music Bank Database/Translation Database. The Module allows a user to:
Find existing data by none or one or more FIND conditions
Sort & Select data
Add, Modify, Delete & Save data by classifications
Translate data
Send Records as SMS/MMS and/or via Email and/or Network Messaging
Copy Current Entry
Print Current Record by different classifications
Go To a Record and Navigate between Records
Bookmark/Unbookmark Record(s)
Attach/Associate File(s)/URLs/Remarks to a Record.

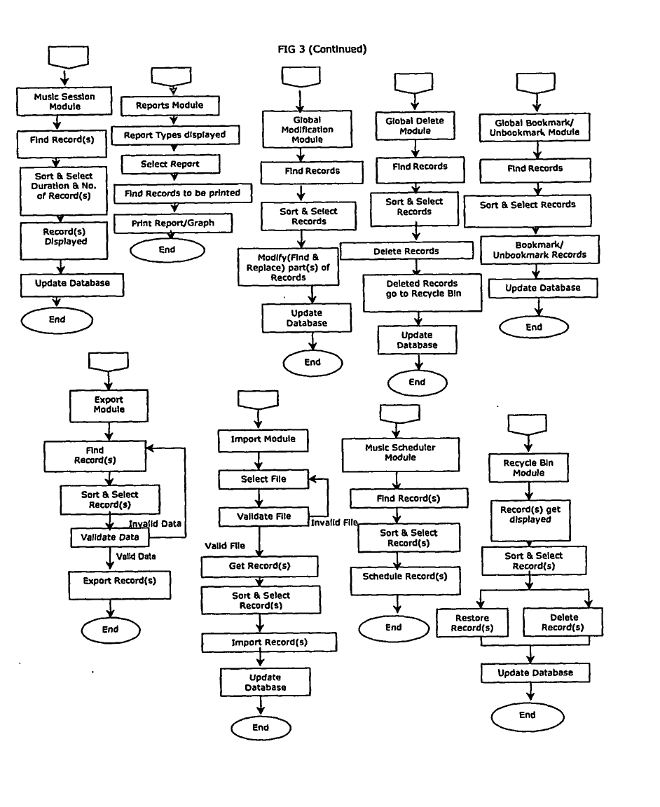

FIG. 5 describes the System Operation of the Music Bank Module explaining that the Module is based on user actions, which are performed by loops. It allows the user to create and store the text and other related information of musical compositions by well-defined classifications with the help of the User Interface.

The Add functionality allows the user to Input data in all the fields. This functionality is controlled through a top-level loop. The Control System updates the Database and then the System waits for the next user action.

The Find functionality is controlled through a top-level loop wherein the user is asked to enter/select a FIND criterion, to bring forth the Record(s) from the Music Bank Database/Translation Database based on the FIND criteria. After finding the Record(s), the user can Sort the Record(s) by different classifications and then can Modify, Delete, or Print the Record(s). After Modification, if the user saves the Record(s), the database gets updated and then the System waits for the next user action. Similarly, after deleting a Record(s), the database gets updated and then the System waits for the next user action.

The Copy Current Entry functionality is controlled through a top-level loop. The System comprises of this utility, while creating a new data Record, of copying an existing entry with respect to at least the above classifications under which the entry may have been stored, such “Copy Current Entry” utility being of immense use to the user to simplify the creation of Records having at least common classifications—EXAMPLE—If a user has an existing Record classified as:

TYPE OF RECORD: SONG

AGE GROUP: SENIORS

GENRE: ENGLISH FILM SONGS

CATEGORY: ROMANTIC SONGS

TITLE: MY HEART WILL GO ON

FIRST LETTER/SYLLABLE/WORD: E

SINGER(S)/BAND(S): CELINE DION

MUSIC DIRECTOR(S)/COMPOSER(S): JAMES HORNER

LYRICIST(S): WILL JENNINGS

FILM/ALBUM: TITANIC

YEAR OF RELEASE OF FILM/ALBUM: 1997

PICTURISED ON: KATE WINSLET, LEONARDO DICAPRIO

SCENE DESCRIPTION: CLOSING SCENE OF THE FILM WHEN THE SHIP IS SINKING

MAIN INSTRUMENT(S): FLUTE, VIOLIN, PIANO

AWARDS: OSCAR AWARD FOR BEST SONG IN 1998

And the new Record being entered by the user also happens to be falling under the above classifications, the “Copy Current Entry” would make the new entry easier for the user, in that, the user would not have to reclassify the new entry.

The Printing functionality is controlled through a top-level loop. The user can Print the Record facing the user, or can Print Record(s) that may have been found by a FIND criterion. The Control System retrieves the Records from the Database and then the System waits for the next user action.

The Bookmark/Unbookmark functionality is controlled through a top-level loop. The user can Bookmark/Unbookmark the Record facing the user, or can Bookmark/Unbookmark Record(s) that may have been found by a FIND criterion. Bookmarking requires that the user Add some remarks to the Bookmark. The Control System updates the Database and then the System waits for the next user action. This functionality also allows the user to Bookmark Record(s) as “Set for Practice” or “Mastered”, “Private” or “Public”, as well as “Favourite”.

The Translation functionality is controlled through a top-level loop. The user can Translate the Record facing the user, or can Translate Record(s) that may have been found from the Music Bank Database/Translation Database by a FIND criterion. Translation allows the user to consider any Record as a parent language Record and Translate the same into one or more languages of the user's choice. The Control System updates the Database and then the System waits for the next user action.

The user can send as SMS/MMS and/or Network Messaging and/or via Email the Record facing the user, or Record(s) that may have been found by a FIND criterion. The user finds the Record(s) by a FIND criterion and sends Record(s) as SMS/MMS and/or Network Messaging and/or via Email. The Control System updates the Database and then the System waits for the next user action.

The user can Attach/Associate file(s) including Image, Animation or Sound Files/URL/Remarks to the Record facing the user, or to the Record(s) that may have been found by a FIND criterion. The Attach/Associate functionality is controlled through a top-level loop. The Control System updates the Database and then the System waits for the next user action.

The Navigation functionality allows the user to Navigate between Records.

On giving Close command the System gets notified and the user comes out from the Module.

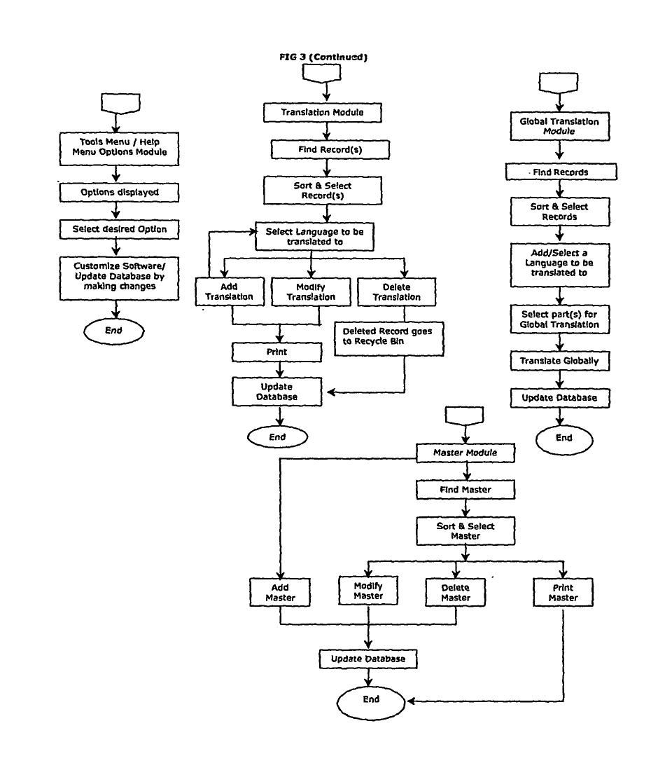

FIG. 6 describes the System State Transition of the Music Bank Module explaining that the Module is based on different States. The System receives events from the user(s), and each event causes the transition from one state to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIG. 7 is the diagram of the System Function of the Global Association Module of the present invention. The architecture of this Module comprises the following functions, which allow a user to Associate File(s)/URLs/Remarks to Records Globally by finding the Records from the Music Bank Database/Translation Database by various classifications with the help of the User Interface.

The Global Association Module through the User Interface causes the Control System to find and Retrieve the relevant data from the Music Bank Database/Translation Database. The Module allows a user to:
Find existing Records from the Music Bank Database/Translation Database by none or one or more FIND conditions
Sort & Select Records
Globally Associate File(s)/URLs/Remarks

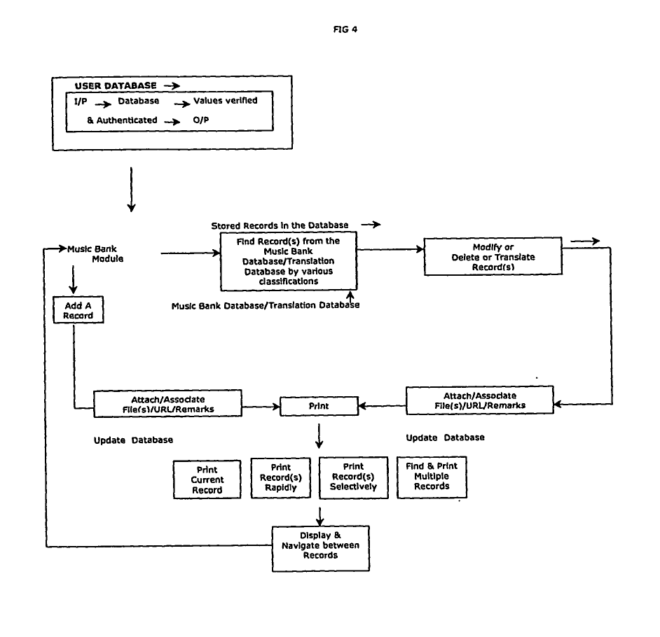

FIG. 8 describes the System Operation of the Global Association Module explaining that the Module is based on user actions, which are performed by loops. Through this Global Association Module, the user can Associate File(s)/URLs/Remarks to Records Globally by finding Records from the Music Bank Database/Translation Database by various classifications with the help of the User Interface.

Once the user finds the Records from the Music Bank Database/Translation Database by various classifications the user can Sort & Select the Records and then the System waits for the next user action. Then the user can Associate File(s)/URLs/Remarks to Records Globally through the User Interface. The System then waits for the next user action.

On giving Close command the System gets notified and the user comes out from the Module.

FIG. 9 describes the System State Transition of the Global Association Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

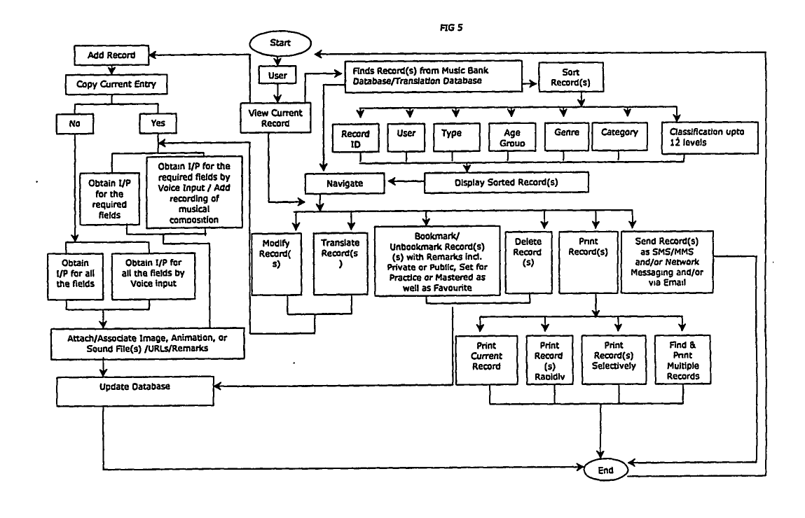

FIG. 10 is the diagram of the System Function of the Global Attachment Module of the present invention. The architecture of this Module comprises the following functions, which allow a user to Attach File(s) to Records Globally by finding the Records from the Music Bank Database/Translation Database by none or one or more FIND conditions with the help of the User Interface.

The Global Attachment Module through the User Interface causes the Control System to retrieve the relevant data from the Music Bank Database/Translation Database. The Module allows a user to:
Find existing Records from the Music Bank Database/Translation Database by none or one or more FIND conditions
Sort & Select Records
Globally Attach File(s)

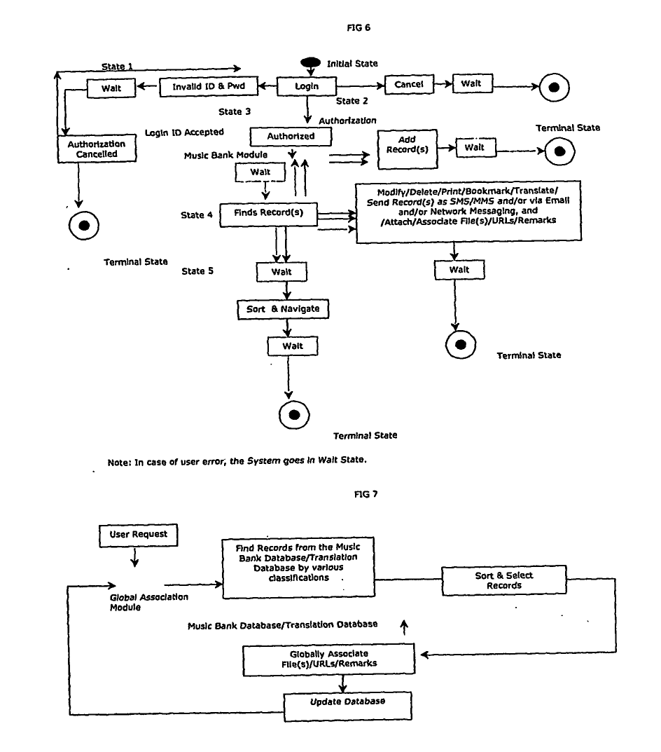

FIG. 11 describes the System Operation of Global Attachment Module explaining that the Module is based on user actions, which are performed by loops. Through this Global Attachment Module, the user can Attach File(s) to Records Globally, by finding Records from the Music Bank Database/Translation Database by none or one or more FIND conditions with the help of the User Interface.

Once the user finds the Records from the Music Bank Database/Translation Database by various classifications the user can Sort & Select the Records and then the System waits for the next user action. Then the users can Attach File(s) to Records Globally through the User Interface. The System then waits for the next user action.

On giving Close command the System gets notified and the user comes out from the Module.

FIG. 12 describes the System State Transition of the Global Attachment Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

The System generates a new Record ID each time a new entry is made by a user or when a Record is Imported by the user.

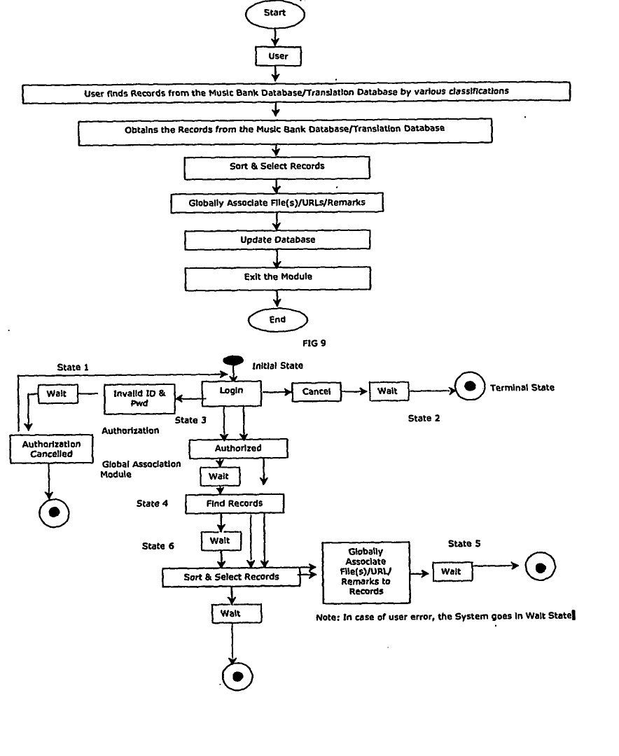

FIGS. 13 to 15 explain the System Function, System Operation and System State Transition respectively, of a Module allowing the user to invoke and store a Music Session, (such Music Session(s) being capable of being taken by more than one user at the same time), using the data stored in the Music Bank Database/Translation Database, and by finding the same based on none or one or more FIND conditions, the find results being displayed to the user with a Timer, the time of display as may be selected by the user, for displaying each of the Record, and the Records being displayed one by one, until the number of Records found by the above FIND conditions are exhausted, or until the user exits the Module, as well as further allowing the user to manually Navigate between the Records being used in the Music Session, as well as further allowing the user to make a selection as to whether the user wishes to listen to and/or view an Attached File or listen to the Background Music Sound File during the Music Session, as well as further allowing the user to make a selection as to whether the user wishes to listen to the text of the Record, which is simultaneously displayed and spoken by a character through an embedded text to speech engine. The Module further comprises of the utility of allowing the user to select the number of Record(s) that the user wishes to use for the Session, the Record(s) being randomly selected from the database, but based on the FIND conditions, and displayed to the user on the user's computer, including hand held devices. The Module further comprises of the utility of allowing the user to repeat the Music Session from the previously stored Music Session(s). The Module further comprises of the utility of allowing the user to assign any previous Music Session as the data input for the purpose of showing the data on the user's screen as a screen saver. A further utility allows the user to send the Record(s) as SMS/MMS and/or via Email and/or Network Messaging during a Music Session.

FIG. 13 is the diagram of the System Function of Music Session Module of the present invention. The architecture of this Module comprises the following functions, which allow a user to invoke a new Music Session using the data stored in the Music Bank Database/Translation Database, and by finding the same based on none or one or more FIND conditions, and to Repeat a Music Session with the help of the User Interface.

The Music Session through the User Interface causes the Control System to find and Retrieve the relevant data from the Music Bank Database/Translation Database. The Module allows a user to:
Select a language
Take a New Music Session by finding the Record(s) from the Music Bank Database/Translation Database, by none or one or more FIND conditions
Repeat a Music Session
Navigate manually(Manual Scroll) or automatically (AutoScroll) between Records during the Music Session
Activate Background Music/Attached Media File during the Music Session
Activate Voice Assistant during the Music Session
Send Record(s)as SMS/MMS and/or Network Messaging and/or via Email during the Music Session

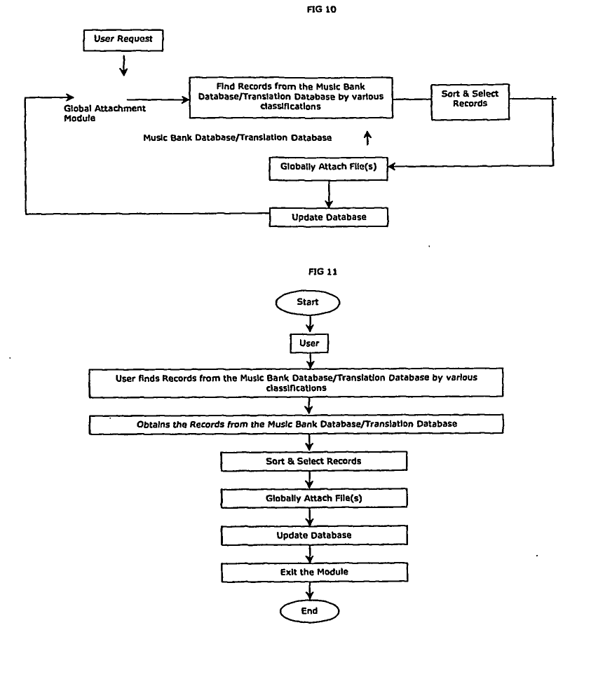

FIG. 14 describes the System Operation of the Music Session Module explaining that the Module is based on user actions, which are performed by loops.

To invoke a New Music Session, the user selects the Language, User Name, Music Session Title, No. of Record(s) and Time per Record and then finds the Record(s) from the Music Bank Database/Translation Database, by none or one or more FIND conditions. The System then waits for the next user action. The user can also listen to a Background Music Sound File or listen to and/or view an Attached File or can activate the Voice Assistant during the Session. The System then waits for the next user action. The user can also assign any previous Music Session for the purpose of showing the data as a screen saver on the user's computer, including hand held devices. The user can also Navigate between the Records and can also jump to any Record at any point of time during the Session, and after this the user can notify the System that the Session is finished. The System stores the Music Session and the database gets updated. The user can also send the Record(s) as SMS/MMS and/or Network Messaging and/or via Email. The System then waits for the next user action.

To Repeat a Music Session, the user selects the desired Music Session from the previously stored Music Session(s) containing the User Name and the Music Session Title. The System then waits for the next user action.

On giving the Close command the System gets notified and the user comes out from the Module.

FIG. 15 describes the System State Transition of the Music Session Module explaining that the Module is based on different States. The

System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

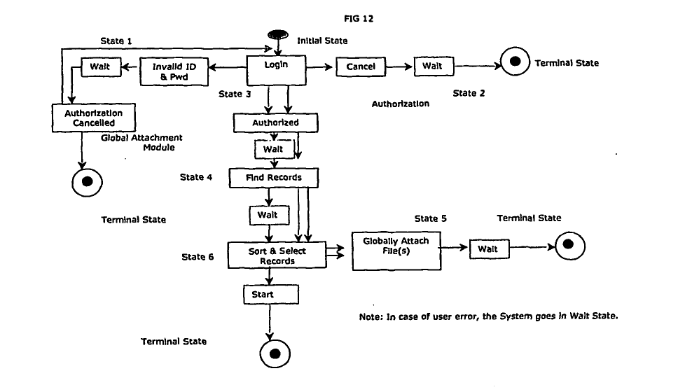

FIGS. 16 to 18 explain the System Function, System Operation and System State Transition respectively of the utility of obtaining the following Reports:
List of Records
List of Records Count by Category
User Details

FIG. 16 is the diagram of the System Function of Reports Module of the present invention. The architecture of this Module comprises the following functions, which allow a user to print Reports and/or Graphs (in case of Records Count by Category and Records Count by Multiple Categories) by finding the Records from the Music Bank Database/Translation Database, by none or one or more FIND conditions with the help of the User Interface.

The Reports Module, through the User Interface, causes the Control System to find and retrieve the relevant data from Music Bank Database/Translation Database. The Module allows a user to:
Select a Report Type
Find existing Record(s) from the Music Bank Database/Translation Database, by none or one or more FIND conditions, to be printed
Print Report/Graph

FIG. 17 describes the System Operation of Reports Module explaining that the Module is based on user actions.

The user selects the Report/Graph to be printed and then Finds & Selects the Records from the Music Bank Database/Translation Database, by none or one or more FIND conditions, to be included in this selected Report/Graph. The System waits for the next user action. The user can Print the selected criteria, if needed. Then the System waits for the next user action. The user can mark the Records to be printed based on the selected criteria. Then the user is able to Print the Records. Then the System waits for the next user action. The user can print the Report and/or Graph based on the selected criteria. The System then waits for the next user action.

On giving the Close command the System gets notified and the user comes out from the Module.

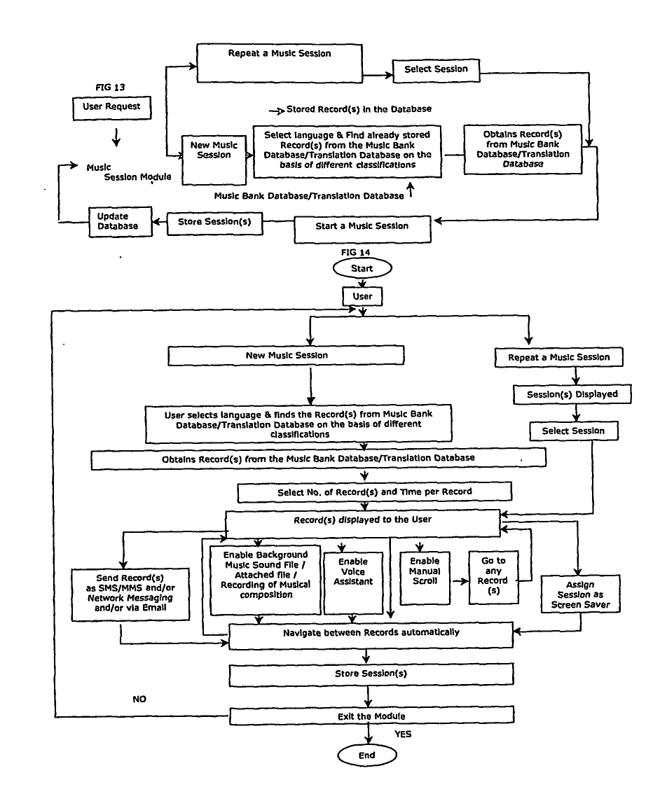

FIG. 18 describes the System State Transition of the Reports Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

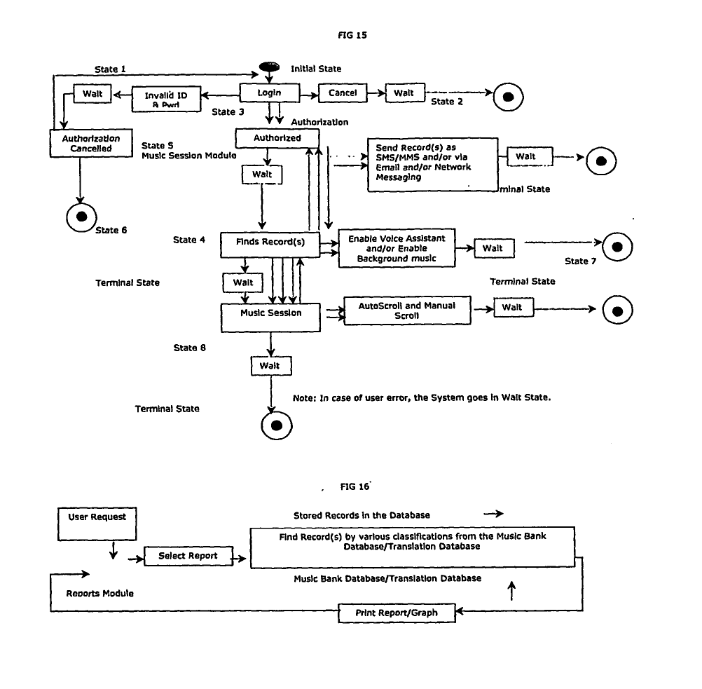

FIGS. 19 to 21 explain the System Function, System Operation and System State Transition respectively of the utility of Modifying a Record stored in the Music Bank Database/Translation Database—EXAMPLE—The System allows the user to Modify any part of an existing Record by using the Edit utility. A Record entered under the Category ROMANTIC SONGS, being decided by the user to be modified, can be instead stored under the Category LOVE SONGS. This would hold true to any part of the Record being wanted to be modified by the user, in that, any part or parts of the Record is allowed to be modified by the user. There is a further utility of “Global Modification” wherein Records can be “Modified” Globally. The Records can be Modified Globally by finding them from the Music Bank Database/Translation Database based on none or one or more FIND conditions, the Results being displayed to the user in a grid format with a further utility to Sort the Results, Ascending or Descending, by some of the relevant classifications, and further allowing the user to select the Records to be Globally Modified from the result grid.—EXAMPLE—The user may want to change the Category of some or all Records having being classified under the Category EASY LISTENING to the Category LOUNGE MUSIC. The Global utility would permit the user to make this Modification across multiple Records instead of Modifying the same one by one.

FIG. 19 is the diagram of the System Function of the Global Modification Module of the present invention. The architecture of this Module comprises the following functions, which allow a user to Modify (Find & Replace) part(s) of the Records Globally, as desired, by finding Records from the Music Bank Database/Translation Database by none or one or more FIND conditions, with the help of the User Interface.

The Global Modification Module through the User Interface causes the Control System to Find and Retrieve the relevant data from the Music Bank Database/Translation Database. The Module allows a user to:
Find existing Records by none or one or more FIND conditions
Sort & Select Records
Modify (Find & Replace) part(s) of Records Globally

FIG. 20 describes the System Operation of the Global Modification Module explaining that the Module is based on user actions.

Once the user finds the Records by various classifications the user can Sort & Select the Records and then the System waits for the next user action. The Control System retrieves the particular Records from the Music Bank Database/Translation Database. Then the user Modifies (Finds & Replaces) part(s) of the selected Records Globally through the User Interface. The System then waits for the next user action.

On giving Close command the System gets notified and the user comes out from the Module.

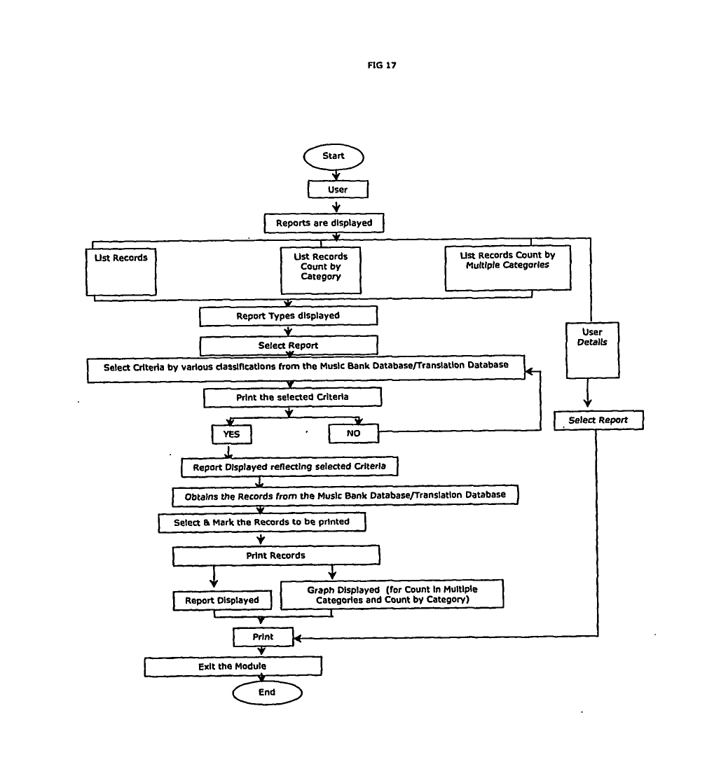

FIG. 21 describes the System State Transition of the Global Modification Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

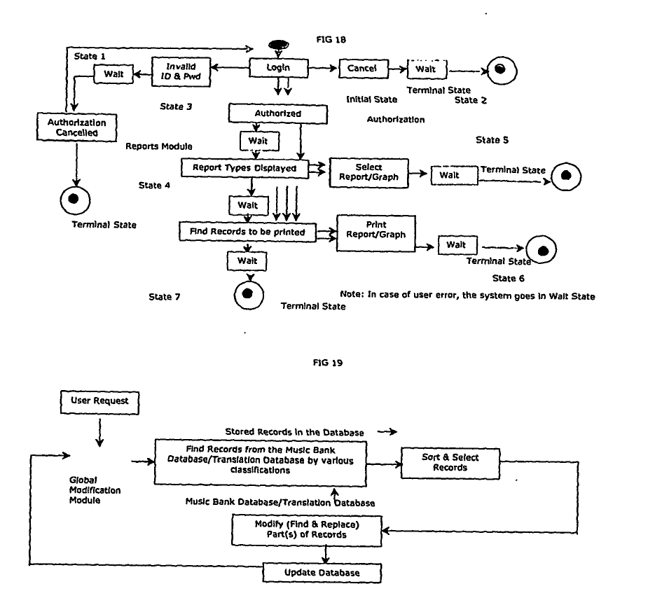

FIGS. 22 to 24 explain the System Function, System Operation and System State Transition respectively of the utility of Deleting a Record stored in the Music Bank Database/Translation Database, and having the further utility of “Global Delete” wherein the user can Select the Records to be Globally Deleted. The Records can be Deleted Globally by Finding them based on none or one or more FIND conditions, the Results being displayed to the user in a grid format with a further utility to Sort the Results, Ascending or Descending, by some of the relevant classifications, and further allowing the user to Select the Records to be Globally Deleted from the result grid. Any Record Deleted is sent to the Recycle Bin Module of the System.

FIG. 22 is the diagram of the System Function of the Global Delete Module of the present invention. The architecture of this Module comprises the following functions, which allow a user to Delete Records Globally by finding the Records from the Music Bank Database/Translation Database by none or one or more FIND conditions with the help of the User Interface.

The Global Delete Module through the User Interface causes the Control System to Find and Retrieve relevant data from the Music Bank Database/Translation Database. The Module allows a user to:
Find existing Records by none or one or more FIND conditions
Sort & Select Records
Delete Records Globally (which goes to Recycle Bin of the System)

FIG. 23 describes the System Operation of the Global Delete Module of the present invention explaining that the Module is based on user actions.

Once the user finds the Records from the Music Bank Database/Translation Database by none or one or more FIND conditions, the user can Sort & Select the Records and then the System waits for the next user action. Then the user Deletes the selected Records through the User Interface. The System then waits for the next user action.

On giving Close command the System gets notified and the user comes out from the Module.

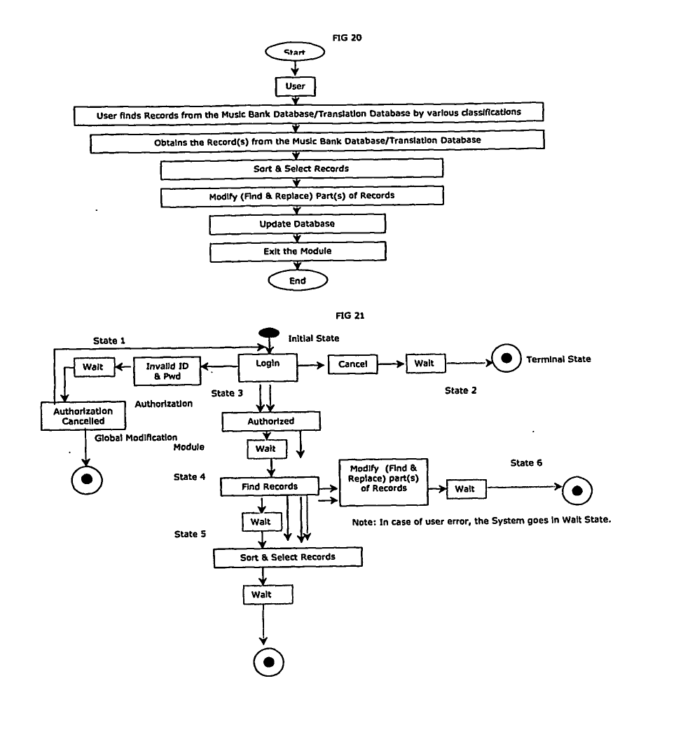

FIG. 24 describes the System State Transition of the Global Delete Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIGS. 25 to 27 explain the System Function, System Operation and System State Transition respectively of the utility of Bookmarking or Unbookmarking one or more already Bookmarked Records in the Music Bank Database/Translation Database, and having the further utility of “Global Bookmark/Unbookmark” wherein the user can Select the Records to be Globally Bookmarked/Unbookmarked, and where the user can make further selections before actually Globally Bookmarking/Unbookmarking the Records. The Records can be Bookmarked/Unbookmarked, Globally in the Music Bank Database/Translation Database, by finding the same based on none or one or more FIND conditions, the Results being displayed to the user in a grid format with a further utility to Sort the Results, Ascending or Descending, by some of the relevant classifications, and further allowing the user to Select the Records to be Globally Bookmarked/Unbookmarked, from the result grid. Bookmarking the Records with any kind of Remarks, including, but not limited to Bookmarking the Records with remarks like “Set for Practice” or “Mastered”, “Private” (indicating that the user has marked the Records as Private, and hence accessible only to the user with the necessary rights) or “Public” (indicating that the Records can be accessed by any user) as well as “Favourite” (indicating that the Records are the user's preferred Records) helps in finding the Records by such Bookmarks.

FIG. 25 is the diagram of the System Function of the Global Bookmark/Unbookmark Module of the present invention. The architecture of this Module comprises the following functions, which allow a user to Bookmark/Unbookmark Records Globally by finding the Records from the Music Bank Database/Translation Database by none or one or more FIND conditions with the help of the User Interface.

The Global Bookmark/Unbookmark Module through the User Interface causes the Control System to Find and Retrieve the relevant data from Music Bank Database/Translation database. The Module allows a user to:
Find existing Records from the Music Bank Database/Translation Database by none or one or more FIND conditions
Sort & Select Records
Globally Bookmark/Unbookmark Records

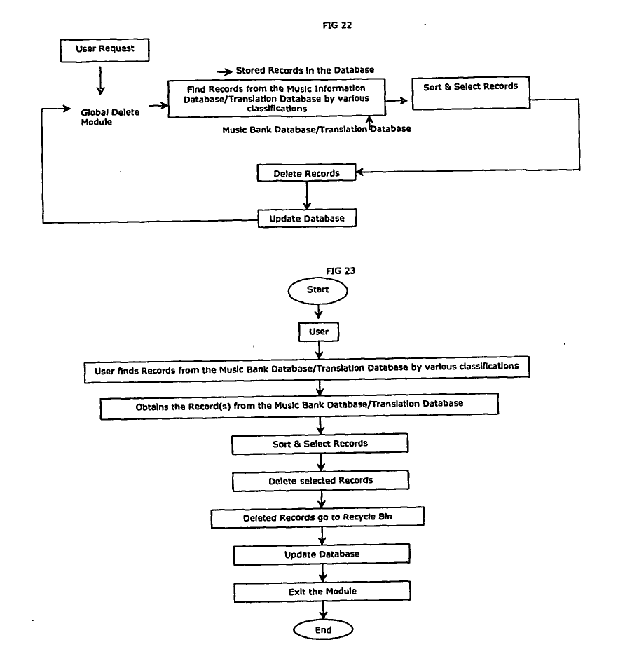

FIG. 26 describes System Operation of the Global Bookmark/Unbookmark Module explaining that the Module is based on user actions.

Once the user finds the Records by various classifications the user can Sort & Select the Records and then the System waits for the next user action. The Control System retrieves the Records from the Database. Then the user can Globally Bookmark/Unbookmark the selected Records through the User Interface. To Bookmark a selected Record, it is essential for the user to Add Bookmark Remarks. The System then waits for the next user action. Any Bookmark Remarks added through this Module would overwrite the Remarks added through the Music Bank Module.

On giving Close command the System gets notified and the user comes out from the Module.

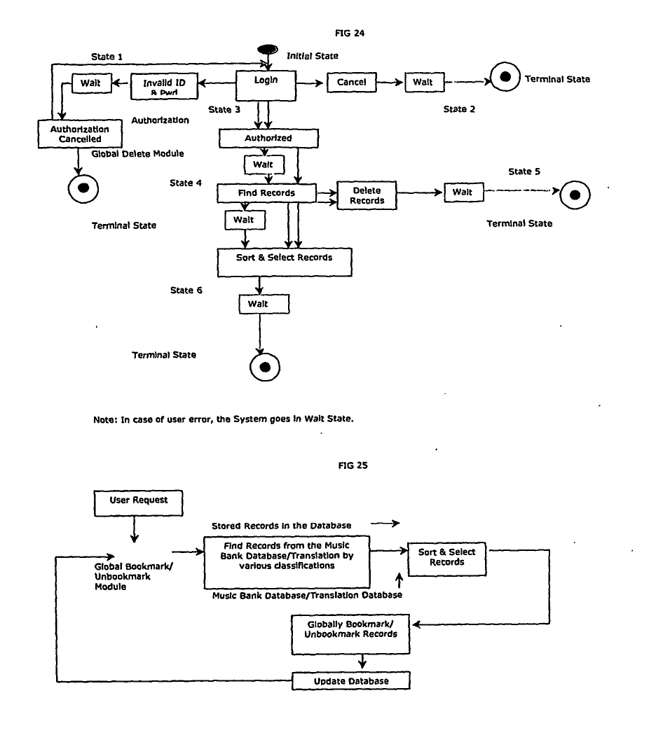

FIG. 27 describes the System State Transition of the Global Bookmark/Unbookmark Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

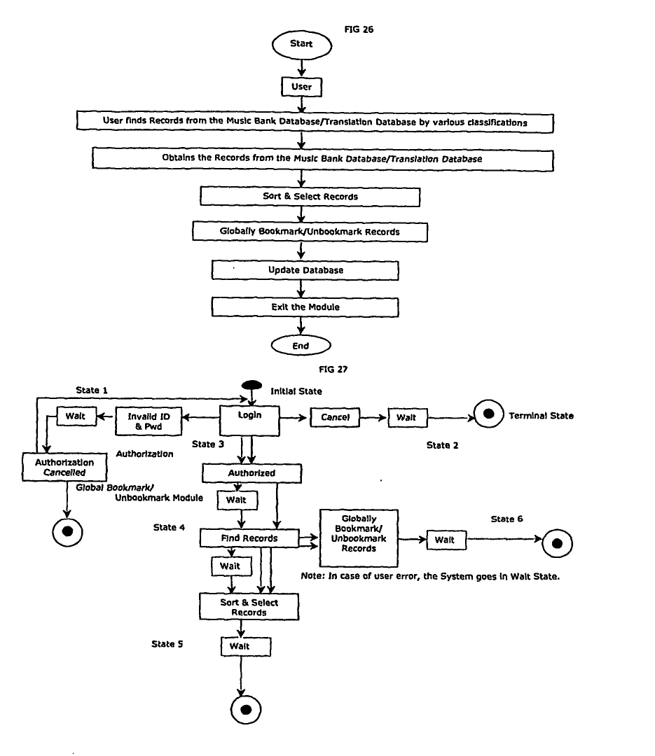

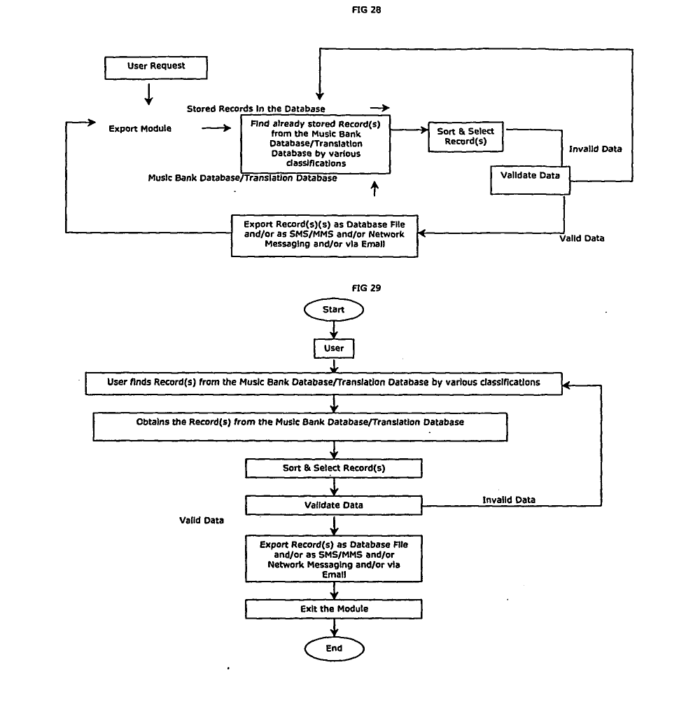

FIGS. 28 to 30 explain the System Function, System Operation and System State Transition respectively of the utility of Exporting Record(s) (by means of a database file created by the System) stored in the Music Bank Database/Translation Database, by finding the same based on none or one or more FIND conditions, the Results being displayed to the user in a grid format with a further utility to Sort the Results, Ascending or Descending, by some of the relevant classifications, and further allowing the user to select the Record(s) to be Exported from the result grid. Records can also be Exported to various destinations by using the Print utility. A further utility allows the user to Export the Record(s) as SMS/MMS and/or via Email and/or Network Messaging.

FIG. 28 is the diagram of the System Function of the Export Module of the present invention. The architecture of this Module comprises the following functions, which allow a user to Export Records by creating a database file and/or as SMS/MMS and/or via Email and/or Network Messaging with the help of the User Interface.

The Export Module through the User Interface causes the Control System to find and retrieve the relevant data from Music Bank Database/Translation database. The Module allows a user to:
Find existing Record(s) from the Music Bank Database/Translation Database, by none or one or more FIND conditions
Sort & Select Record(s)
Validate Data
Export Record(s) as Database File and/or as SMS/MMS and/or via Email and/or Network Messaging

FIG. 29 describes the System Operation of the Export Module explaining that the Module is based on user actions, which are performed by loops.

Once the user finds the Record(s) from the Music Bank Database/Translation Database by none or one or more FIND conditions, the System returns to the top-level loop, and waits for the next user action. The user can Sort & Select the desired Record(s) and then after data validation can Export the Record(s) as Database File and/or as SMS/MMS and/or via Email and/or Network Messaging. Then the System waits for the next user action.

On giving Close command the System gets notified and the user comes out from the Module.

FIG. 30 describes the System State Transition of the Export Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIGS. 31 to 33 explain the System Function, System Operation and System State Transition respectively of the utility of Importing Record(s) from a database file that may have been created by another user of this System, with the utility of appending the data already stored by the user in the Music Bank Database/Translation Database. The utility further comprises of displaying the Importable Record(s) to the user in a grid format with a further utility to Sort the data, Ascending or Descending, by the relevant classifications. The utility further allows the user to make a selection of the data to be Imported; thereby allowing the user to Import only such data as may be required by the Importing user.

FIG. 31 is the diagram of the System Function of the Import Module of the present invention. The architecture of this Module comprises the following functions, which allow a user to Import Records with the help of the User Interface from a database file that may have been created by another user of this System.

The Import Module through the User Interface causes the Control System to retrieve the relevant data from a valid database file. The Module allows a user to:
Select File
Validate File
Get Record(s)
Sort & Select Record(s)
Import Record(s)

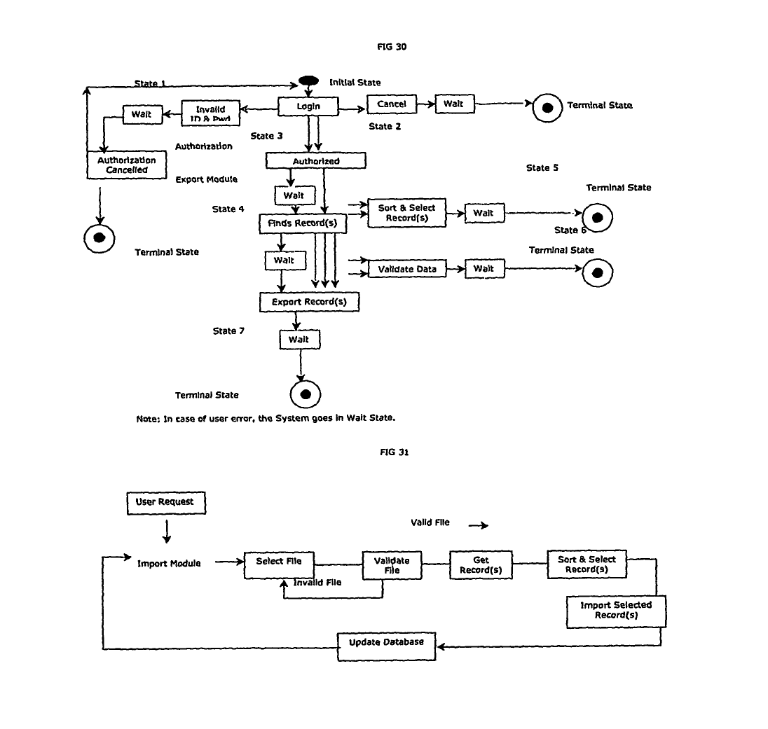

FIG. 32 describes the System Operation of Import Module explaining that the Module is based on user actions, which are performed by loops. The Import Module allows the user to Import selected Record(s) from a database file that may have been created by another user of this System.

Once the user retrieves the Record(s) after File Validation the System returns to the top-level loop, and waits for the next user action. The user can Sort & Select the desired Record(s)and then can Import the Record(s) selectively, if needed. Then the System waits for the next user action.

On giving Close command the System gets notified and the user comes out from the Module.

FIG. 33 describes the System State Transition of the Import Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

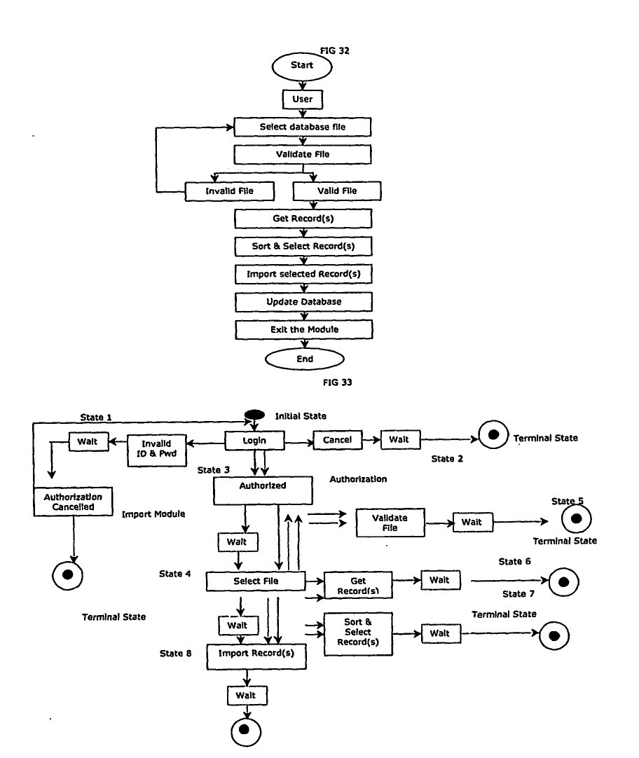

FIGS. 34 to 36 explain the System Function, System Operation and System State Transition respectively, of the utility of allowing the user to Schedule the Records by finding the same from the Music Bank Database/Translation Database, based on none or one or more FIND conditions, and to be brought up on the user's computer, including hand held devices, at preset time intervals, with or without Voice, in the case of with voice, the text of Records being additionally displayed on the user's computer, including hand held devices, and simultaneously being spoken by a character, through an embedded text to speech engine and further that the user has the ability to selectively Schedule Records. The Module also comprises of the utility of allowing the user to activate recording of the musical composition in the user's own voice, Attached Image, Animation, and File(s) further utility allows the user to send the Record as SMS/MMS and/or via Email and/or Network Messaging at any time before the Scheduling activity is over.

FIG. 34 is the diagram of the System Function of the Music Scheduler Module of the present invention. The architecture of this Module comprises the following functions, which allow a user to find the Record(s) from the Music Bank Database/Translation Database by none or one or more FIND conditions and Schedule them as desired with the help of the User Interface.

The Music Scheduler Module through the User Interface causes the Control System to find and retrieve the relevant data from the Music Bank Database/Translation database. The Module allows a user to:
Select a language
Find existing Record(s) from the Music Bank Database/Translation Database by none or one or more FIND conditions
Sort & Select Records
Schedule time interval between the selected Records
Activate Background Music Sound File or Attached File
Activate Voice Assistant
Send Record(s) as SMS/MMS and/or via Email and/or Network Messaging when the Record is displayed

NOTE: The Scheduler remains active in the system tray of the user's computer, irrespective of whether the System is running or not.

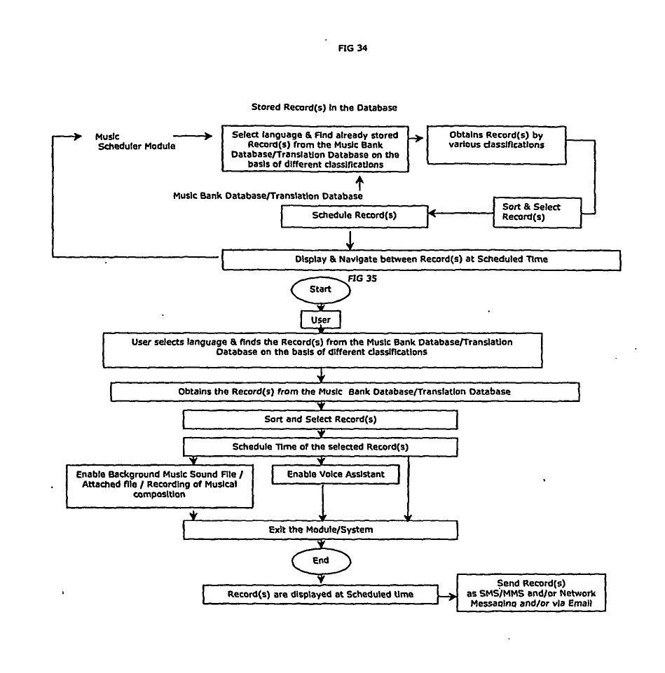

FIG. 35 describes the System Operation of the Music Scheduler Module explaining that the Module is based on user actions, which are performed by loops.

The user selects the language, No. of Records and then finds the Record(s) from the Music Bank Database/Translation Database, by none or one or more FIND conditions. The System then waits for the next user action. The user can also select to listen to the Background Music Sound File or can select to activate the Voice Assistant during the Scheduling activity and after this the user can notify the System that the Scheduling activity is finished. The System then waits for the next user action. The Records get displayed according to the specified time. The user can also send the Record(s) as SMS/MMS and/or via Email and/or Network Messaging. The System then waits for the next user action.

On giving Close command the System gets notified and the user comes out from the Module.

FIG. 36 describes the System State Transition of the Music Scheduler Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

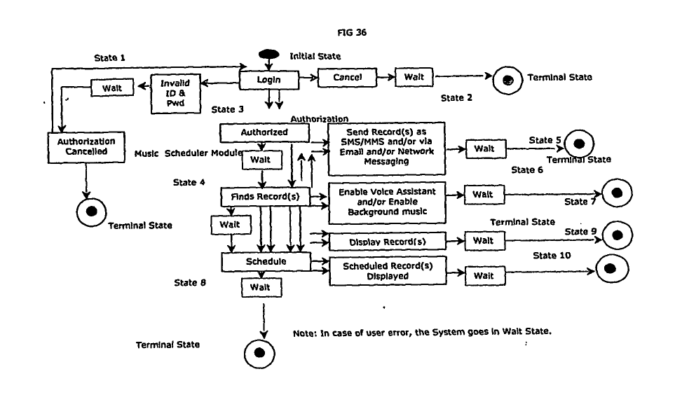

FIGS. 37 to 39 explain the System Function, System Operation and System State Transition respectively, of the utility of Restoring or Deleting a Record, which may have been Deleted by the user from the Music Bank Database/Translation Database, and having the further utility of selectively Restoring or Deleting a Record or a group of Records, the Records being displayed to the user in the Recycle Bin Module in a grid format with a further utility to Sort the Results, Ascending or Descending, by some of the relevant classifications, and further allowing the user to select the Records to be selectively Deleted or Restored from the result grid. Any Record Restored is sent back to the Music Bank Database/Translation Database, with its original ID Number. Any Record that is Deleted from the Recycle Bin Module is permanently removed from the System.

FIG. 37 is the diagram of the System Function of the Recycle Bin Module of the present invention. The architecture of this Module comprises the following functions, which allow a user to Restore/Delete Record(s) with the help of the User Interface.

The Recycle Bin Module through the User Interface causes the Control System to display the deleted data of Music Bank Database/Translation database. The Module allows a user to:
Sort & Select Record(s)
Restore/Delete Record(s)

FIG. 38 describes the System Operation of the Recycle Bin Module explaining that the Module is based on user actions.

The selection utility of Recycle Bin Module displays all the Records, that may have been deleted earlier, and are still lying in the Recycle Bin of the System. The user can Sort & Select these displayed Records. The System then waits for the next user action. The user is allowed to either to Delete or Restore the selected Records through the User Interface. The System then waits for the next user action. The System exercises sufficient caution to ensure that any Record(s) or Master(s) of Records that are in use in a Music Session or a Scheduled Session are not permanently removed.

On giving Close command the System gets notified and the user comes out from the Module.

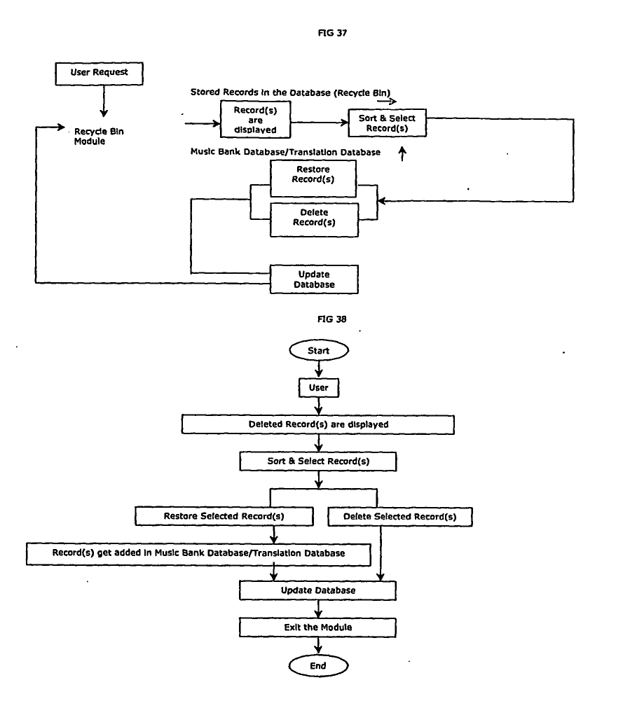

FIG. 39 describes the System State Transition of the Recycle Bin Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

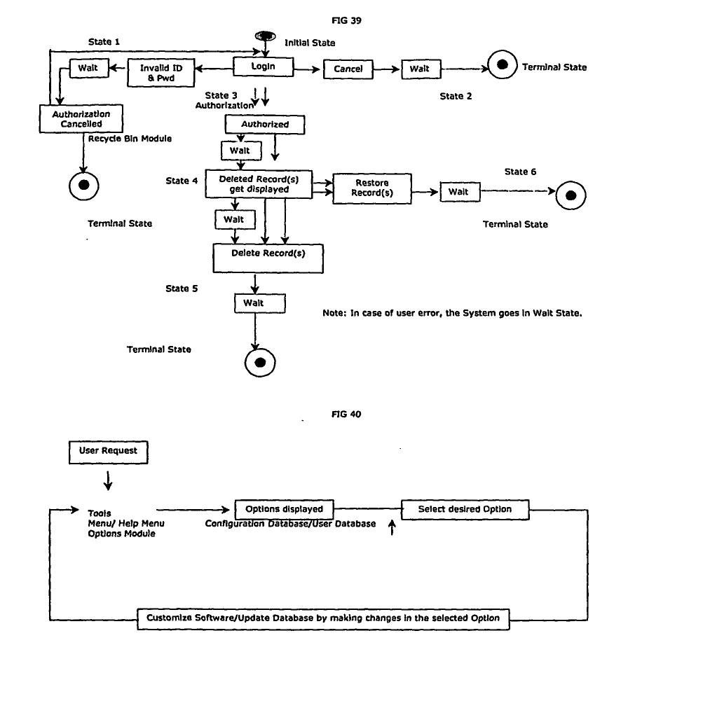

FIGS. 40 to 42 explain the System Function, System Operation and System State Transition respectively, of the Tools/Help Menu Options Module comprising of software maintenance Tools such as Back Up, Restore, and Compression of the entire database and System Check. There are other tools such as Start Up options, Data Entry Options, Change Sound, Customize Header and Footer, Graphical User Interface Manager, Labels, Select Skin, Remove Music Session(s) and Help. The System allows the creation of Sub Users who are able to set their own preferences with respect to the relevant tools.

FIG. 40 is the diagram of the System Function of the Tools/Help Menu Options Module of the present invention. The architecture of this Module comprises the following functions, which allow a user to select any option for Customization including software maintenance and updating of Database.

The Tools/Help Menu Options Module, through the User Interface, retrieves and brings forth the following options:
Back Up—This utility allows the user to back up the entire Database
Repair/Restore/Compress—This utility allows the User to Repair/Restore/compress the entire Database
Change Sound—This utility allows the user to change the background sounds
System Check—This utility allows the user to initiate a System check
Start Up Options—This utility allows the user to set conditions like Login Screen and Quick Start Screen to appear each time the System is initiated
Customize Header and Footer—This utility allows the user to customize the Header and Footer for the Printed outputs.
Select Skin—This utility allows the user to select the “skins” for the Graphical User Interface.
Data Entry Options—This utility allows the user to copy an existing classification and previously entered data for new data input.
Label Printing—This utility allows the user to Print the user information labels.
Graphical User Interface Manager—This utility allows the user to change the labels that appear on the Graphical User Interface.
User Information—This utility allows the user to modify the information entered by the user during registration of the System.
Classification wise Records Count—This utility allows the user to view Records stored under particular Classification.
Remove Music Session(s)—This utility allows the user to Delete Music Session(s), such deletions capable of being made selectively.
Help—This utility allows the user to invoke the Help files, which provide Help on how best to use the System.

FIG. 41 describes the System Operation of the Tools/Help Menu Options Module explaining that the Module is based on user actions. Through this Module, the user can select any option for Customization, including software maintenance and updating of Database.

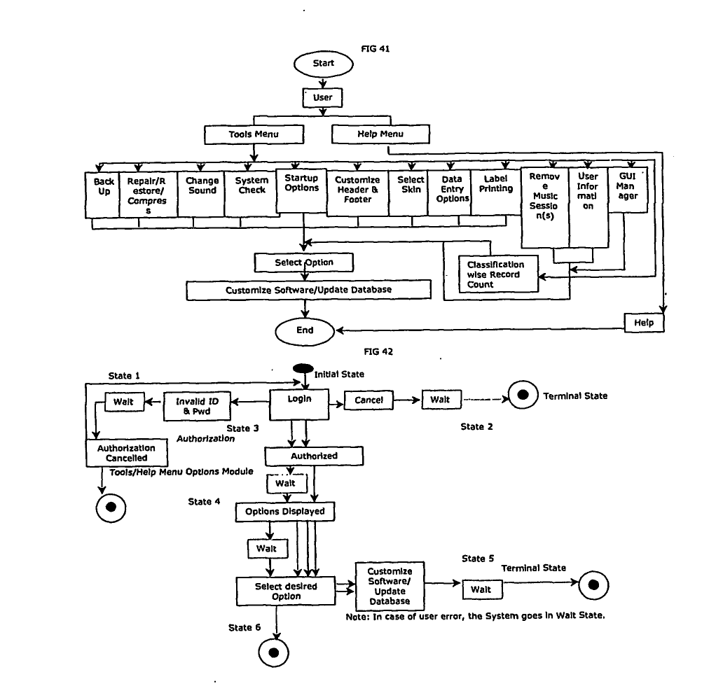

FIG. 42 describes the System State Transition of the Tools/Help Menu Options Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

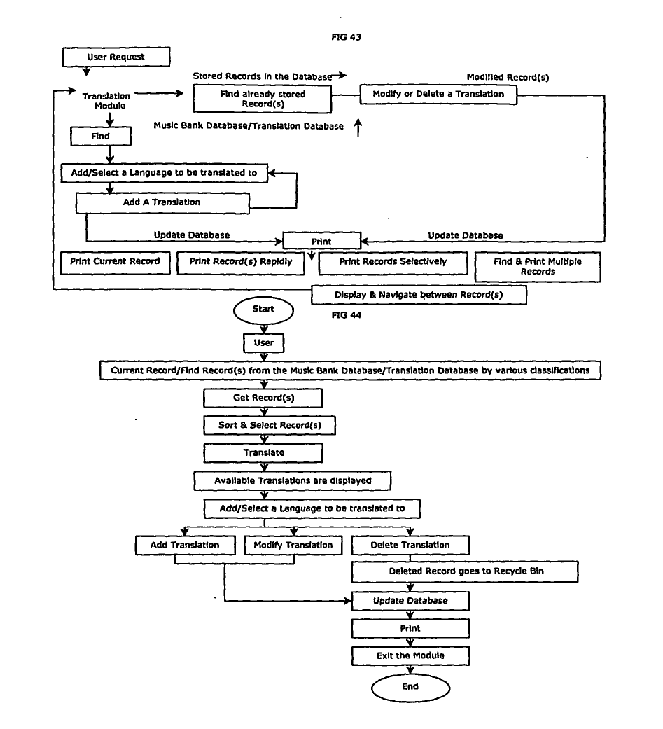

FIGS. 43 to 48 explain the System Function, System Operation and System State Transition respectively, of a Translation utility, allowing the user to consider any Record as a parent language Record and Translate the same into one or more languages of the user's choice, the translation activity happening from a Translation Module which is invoked in the Music Bank Module, and further that all of the features and/or utility(s)/functionality(s) of the System remaining common to the translated Record as would be applicable to the parent language Record. There is a further utility of “Global Translation” where Record(s) can be found and part(s) of the Record(s) can be translated Globally. The Records can be translated Globally by finding them from the Music Bank Database/Translation Database, by none or one or more FIND conditions, the Results being displayed to the user in a grid format with a further utility to Sort the Results, Ascending or Descending, by some of the relevant classifications, and further allowing the user to select the Records to be Globally translated from the result grid.—EXAMPLE—The User may want to Translate the Category of some or all Records having been classified under ROMANTIC SONGS from English to Spanish. The Global utility would permit the user to Translate this across multiple Records instead of translating the same one by one.

FIG. 43 is the diagram of the System Function of the Translation Module of the present invention. The architecture of this Module comprises the following functions, which allow a user to consider any Record as a parent language Record and Translate the same into one or more languages of the user's choice.

The Translation Module through the User Interface causes the Control System to find and retrieve the relevant data from the Music Bank Database/Translation database. The Module allows a user to:
Find existing Records from the Music Bank Database/Translation Database by none or one or more FIND conditions
Sort & Select Records
Select/Add a language
Add Translations
Modify Translations
Delete Translations
Print

FIG. 44 describes the System Operation of Translation Module explaining that the Module is based on user actions, which are performed by loops. The user finds the Records from the Music Bank Database/Translation Database, by none or one or more FIND conditions. The user then Sorts & Selects the Records and then the System waits for the next user action. Then the user selects a Record to be translated and translates the same field by field through the User Interface. The user can also Modify an earlier translation or Delete the same. The System then waits for the next user action. The user is able to Print the Record from this Module after selecting the appropriate Print criterion. The System waits for the next user action.

On giving Close command the System gets notified and the user comes out from the Module.

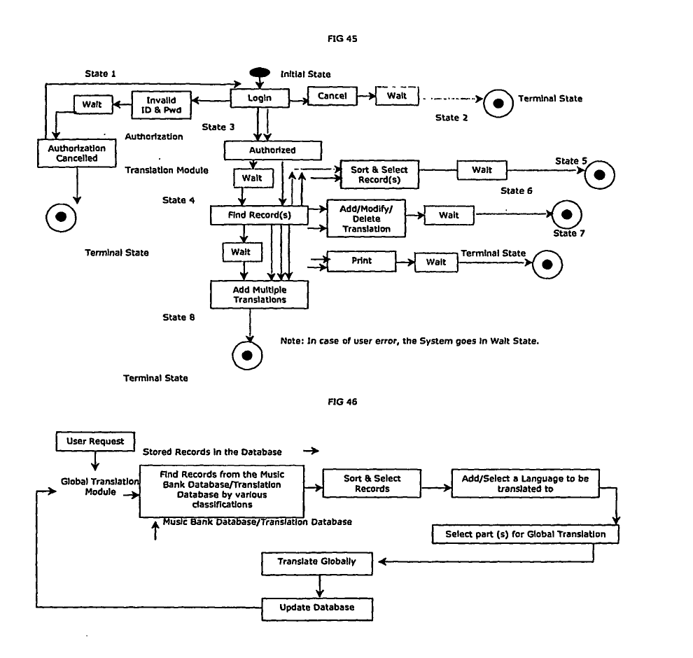

FIG. 45 describes the System State Transition of the Translation Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIG. 46 is the diagram of the System Function of the Global Translation Module of the present invention. The architecture of this Module comprises the following functions, which allow a user to Translate selected part(s) of the parent language Record(s) across several Records Globally in any language of the user's choice.

The Global Translation Module through the User Interface causes the Control System to find and Retrieve the relevant data from the Music Bank Database/Translation Database. The Module allows a user to:
Find existing Records from the Music Bank Database/Translation Database by none or one or more FIND conditions
Sort & Select Records
Select/Add a language
Select part(s) for Global Translation
Translate Globally

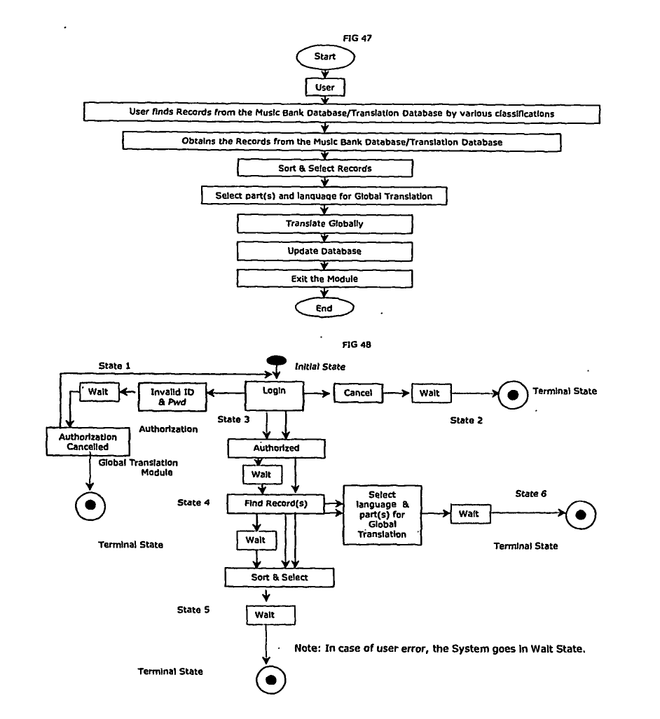

FIG. 47 describes the System Operation of Global Translation Module explaining that the Module is based on user actions.

Once the user finds the Records from the Music Bank Database/Translation Database by none or one or more FIND conditions,

the user can Sort & Select the Records and then the System waits for the next user action. Then the user can select part(s) of the found Records and Translate the same across multiple Records through the User Interface, instead of translating the same one by one. The System waits for the next user action.

On giving Close command the System gets notified and the user comes out from the Module.

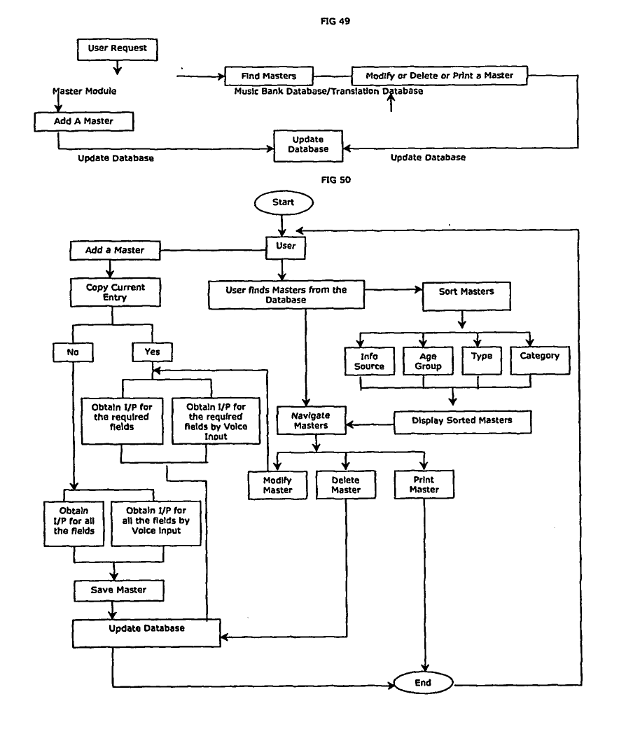

FIG. 48 describes the System State Transition of the Global Translation Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIGS. 49 to 51 explain the System Function, System Operation and System State Transition respectively, of the Master Module which accepts data (such data capable of being accepted from more than one user at the same time), with or without Voice, from the user. The System provides the utility of creating, editing, deleting, printing, navigating, finding Masters like: Type of Record, Age Group, Genre, Category, First Letter/Syllable/Word, Singer(s)/Band(s), Film/Album, Lyricist(s), Music Director(s)/Composer(s). Sufficient security is provided by the System, so as not to allow the deletion of any Master of a Record that may be in use.

FIG. 49 is the diagram of the System Function of the Master Module of the present invention. The architecture of this Module comprises the following functions, which allow a user to create and store Masters with the help of the User Interface.

The Master Module through the User Interface causes the Control System to retrieve the relevant data from the Music Bank Database/Translation database. The Module allows a user to:
Find existing Master(s) from the Music Bank Database/Translation database by none or one or more FIND conditions
Sort & Select Master(s)
Add & Save Master(s)
Modify & Save Master(s)
Delete Master(s)
Copy Current Entry
Print Master(s)
Go To a Master

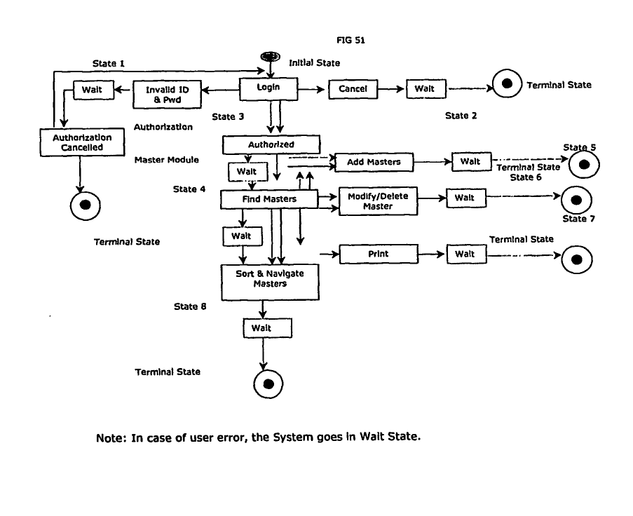

FIG. 50 describes the System Operation of the Master Module explaining that the Module is based on user actions, which are performed by loops.

The Add functionality allows the user to Input data in the relevant fields. The functionality is controlled through a top-level loop. The Control System updates the Database and then the System waits for the next user action.

The Find functionality is controlled through a top-level loop wherein the user is asked to enter/select the FIND criteria, to bring forth Masters based on the FIND criteria. After finding the Masters, the user can Sort the Masters by different classifications and then can Modify, Delete or Print the Masters. After modification, if the user saves the Master, the database gets updated and then the System waits for the next user action. Similarly, after deleting a Master, the database gets updated and then the System waits for the next user action.

The Copy Current Entry functionality is controlled through a top-level loop. This functionality allows the user to copy the data existing in one or more of the current Masters and make the necessary additions/modifications in the other fields. The Control System updates the new Master in the Database and then the System waits for the next user action.

The Printing functionality is controlled through a top-level loop. The user can Print the Masters. The Control System retrieves the Master(s) from the Database and then the System waits for the next user action. The Navigation functionality allows the user to Navigate between Masters.

On giving Close command the System gets notified and the user comes out from the Module.

FIG. 51 describes the System State Transition of the Master Module explaining that the Module is based on different States. The System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1-15. (canceled)

16. An interactive system for building and sharing one's own databank of atext and other related information of musical compositions, in one or more languages, using a computer system comprising:
(a) a User Interface;
(b) one or more well-classified databases to store data user wise including a User Database;
(c) at least one well-classified data input organizing and management module;
(d) modules for sharing, invoking, storing, and improving one's knowledge of the text and other related information of musical compositions including songs, hymns, ghazals, using the data from the databank, said data having been selected by a user by finding the same by none or one or more “FIND” conditions; and
(e) a control system acting as a bridge between the User Interface and the databases.

17. The system according to claim 16 wherein the modules include a Music Session Module allowing the user to invoke and store a music session for improving one's knowledge of the text and other related information of musical compositions including songs, hymns, ghazals, using the data from the databank, such data having been selected by the user by finding the same by none or one or more “FIND” conditions.

18. The system according to claim 16 wherein the modules include a Music Scheduler Module for allowing the user to schedule the data comprising of the text and other related information of musical compositions including songs, hymns, ghazals, by finding the same from the databank by none or one or more “FIND” conditions and said songs, hymns, ghazals are brought up on the user's computer system at preset time intervals.

19. The system according to claim 16 wherein the modules include an Export Module for allowing the users to export data from the databank, said data having been selected by one or more users by finding the same by none or one or more “FIND” conditions.

20. The system according to claim 16 wherein the modules include an Import Module for allowing one or more users to import data built by other user(s).

21. The system according to claim 20 wherein the Import Module further includes a utility for selectively importing the data.

22. The system according to claim 16 wherein said data input organizing and management module allows the user to classify the data by well-defined classifications like Date, Type of Record, Age group, Language, Genre, Category, Title, First Letter/Syllable/Word, Singer(s)/Band(s), Film/Album, Lyricist(s), Music Director(s)/Composer(s), Year of Release, Picturised on, Scene Description, Award(s), Main Instrument(s).

23. The system according to claim 16 wherein the modules include a Global Attachment Module for allowing the user to attach image, animation, or sound files to a record.

24. The system according to claim 16 wherein the modules include a Global Association Module for allowing the user to associate files, URLs, or remarks to a record.

25. The system according to claim 16 wherein said data input organizing and management module further includes a utility for copying of existing classification and previously entered data for new data input by the user for ease of data entry.

26. The system according to claim 16 wherein the modules include a Global Modification Module for allowing the user to modify a record individually and globally.

27. The system according to claim 16 wherein the modules include a Global Delete Module for allowing the user to delete a record individually and globally.

28. The system according to claim 16 wherein the modules include a Recycle Bin Module for allowing the user to restore or permanently remove a record individually or plurally from the system.

29. The system according to claim 16 wherein the modules include a Reports Module for allowing a user to print reports and/or graphs about the data in the databank, by finding the same by none or one or more “FIND” conditions.

30. The system according to claim 16 wherein the “FIND” conditions are defined by classifications like the Date, Record ID, Language, Type of Record, Age group, Genre, Category, Title, First Letter/Syllable/Word, Singer(s)/Band(s), Film/Album, Lyricist(s), Music Director(s)/Composer(s), Year of Release, Picturised on, Scene Description, Award(s), Main Instrument(s), as well as by keywords, wildcards, rile attachments or bookmark remarks, including “Set for Practice” or “Mastered”, “Public” or “Private” or “Favourite”.

31. The system according to claim 16 wherein the modules include a Global Bookmark/Unbookmark Module for allowing the user to bookmark or unbookmark the records individually or globally with bookmark remarks including “Set for Practice” or “Mastered”, “Public” or “Private”, or “Favourite”.

32. The system according to claim 16 wherein the modules include a Translation Module as well as a Global Translation Module for allowing translation of a record from one language into another of the user's choice, individually or globally.

33. The system according to claim 16 wherein the modules include a Tools/Help Menu Options Module for allowing the user to select an option for customization including system maintenance and updating of database.

34. The system according to claim 16 wherein the modules include a Master Module for allowing the user to create and store masters for well-defined classifications.

35. The system according to according to claim 16 wherein the modules and utilities are adapted to be operated within a browser and/or other viewing and/or processing programs and to operate on one or more computer systems including hand held devices.
